(19) United States
(12) Patent Application Publication
(10) Pub. No.: US 2026/0277970 A1
(43) Pub. Date: Sep. 17, 2026

(54) SYSTEMS AND METHODS FOR UTILIZING A TIME-TO-TRUTH (TTT) METRIC FOR KNOWLEDGE MANAGEMENT

(71) Applicant: CVS Pharmacy, Inc., Woonsocket, RI (US)

(72) Inventor: Victor A. Danilchenko, Woonsocket, RI (US)

(21) Appl. No.: 19/076,214

(22) Filed: Mar. 11, 2025

(51) Int. Cl. G06F 16/334; G06F 16/332; G06F 16/3329

(52) U.S. Cl. CPC G06F 16/3347; G06F 16/3326

(57) ABSTRACT

A method is provided. The method comprises obtaining time-to-truth (TTT) information associated with a result of a federated knowledge base (KB) computing platform providing a plurality of responses to a user query from a user device of a user. The TTT instrumentation information indicates user feedback information and/or journey information associated with the user query. The method further includes determining a TTT metric based on the TTT instrumentation information, and the TTT metric indicates a parameter for the federated KB platform to provide a response, from the plurality of responses, that answers the user query. The method also includes updating the search vectors associated with the plurality of documents that are stored in the KB metadata and vector database based on the TTT metric. The updated search vectors are used to generate one or more subsequent responses to a subsequent user query.

### BACKGROUND

Knowledge management (KM) may be a process of organizing, creating, using, and/or sharing collective knowledge within the enterprise organization, and successful KM includes maintaining information in a place where it is easy to access such as an employee intranet. For enterprise organizations, KM may become an especially important practice, and the larger the enterprise organization, the more crucial KM becomes. Typically, the KM practice may be carried out using knowledge bases (KB) (e.g., a central repository that stores knowledge documents such as travel policies for the enterprise organization). For example, multiple entities (e.g., authors, publishers, and/or subject matter experts (SMEs)) may author, publish, and/or certify documents that are stored within KBs. However, centralization of the KBs may be difficult to implement, particularly in large enterprises with inconsistent organizational practices and cultural norms across organizational units.

Furthermore, identifying the correct document for retrieval based on a user request may also be difficult for larger enterprise organizations given the numerous documents that are stored across numerous different KBs. For example, a user (e.g., an employee) may provide a query such as a human resource (HR) query that asks whether personal plates are allowed in the break room. The enterprise organization may utilize a search engine to search the KBs for a response to the user and provide the result (e.g., links to one or more documents from the KBs) back to the user. However, the result may indicate documents that are not relevant to the query such as documents associated with electric plates instead of dinner plates. Traditional search algorithms and processes may include metadata for each of the documents that indicate the relevance of the documents, and they may update the document metadata based on user feedback regarding the results. However, in the above example, the relevance of the documents might not be at issue and instead, the search engine and process may have caused the irrelevant results. Accordingly, there remains a technical need to utilize metrics for knowledge management to improve document retrieval and identification within KBs.

### SUMMARY

In some examples, the present application provides a method and system for utilizing a time-to-truth (TTT) metric for knowledge management (KM). For example, an enterprise organization may provide a plurality of different services to individuals (e.g., consumers) such as a grocery pick-up service, a prescription pick-up service, an insurance service, a streaming service, and/or other services. In order to provide the plurality of the different services, the enterprise organization may utilize knowledge bases (KBs) that store a plurality of documents. A set of the plurality of documents may be certified documents. A user such as a consumer and/or employee of the enterprise organization may have a question associated with the enterprise organization and may use a user device to provide a query to a search system associated with the enterprise organization (e.g., a search system within a federated KB computing platform). The search system may utilize search processes and/or algorithms to respond to the prompt such as by searching through KBs associated with the enterprise organization to retrieve documents and/or identifiers (e.g., links) associated with the documents. The search system may then provide the search results (e.g., the documents themselves or links indicating a storage location of the documents within the KBs) back to the user device. The user may then review the results to their query. In some examples, the user may be satisfied by their query, but in other examples, the user might not be satisfied with their query and may seek to modify their query in order to obtain better search results.

A system or computing platform associated with the search system (e.g., the federated KB computing platform) may obtain information (e.g., TTT instrumentation information) associated with the results from the user's query such as user quality feedback information and/or journey information. For example, the user quality feedback information may be based on direct user feedback (e.g., user input) indicating whether the results from the search system are relevant. For instance, if the results are not relevant, the user device may obtain user input indicating a “not relevant” flag (e.g., a thumbs down). Furthermore, the journey information may indicate data for the user such as a time duration that the user spent reviewing a particular result (e.g., a longer time duration may indicate that the document is more relevant than a shorter time duration). Subsequently, based on the user quality feedback information and/or journey information, a TTT metric may be determined. The TTT metric may indicate a metric for the user to be satisfied with the results from the search system. For example, if the user is required to supplement their initial query with a second query (e.g., based on the journey information), this may indicate that the results from the first query were inadequate and thus, the TTT metric may reflect the inadequacy of the search system.

Based on the TTT metric, the search system and/or process may be updated in order to generate more relevant results to subsequent queries. For example, based on the TTT metric, the instrumentation of the knowledge discovery process may be updated. Additionally, and/or alternatively, the search system may use a machine learning-artificial intelligence (ML-AI) model or algorithm such as a retrieval-augmented generation (RAG) artificial intelligence (AI) model. Based on the TTT metric, the RAG AI model may be updated and/or improved further. Additionally, and/or alternatively, one or more documents may be certified by one or more subject matter experts (SMEs). Based on the TTT metric, the SMEs may update the metadata associated with the document. For example, the SMEs may review the distinction between user intent and document intent and determine whether to update the metadata associated with the document. For instance, the document might not have addressed the user query, but does a great job of addressing its own topic. Thus, the SMEs might not update the document metadata. This will be described in further detail below.

In one aspect, a system is provided. The system comprises: a user device configured to: provide, based on user input from a user, a user query to a federated knowledge base (KB) computing platform; and obtain, from the federated KB computing platform and based on the user query, a plurality of responses indicating a plurality of documents that are stored in one or more KBs. The system further comprises: a federated knowledge base (KB) computing platform configured to: obtain the user query from the user device; generate the plurality of responses indicating the plurality of documents based on utilizing a KB metadata and vector database that stores search vectors associated with the plurality of documents from the one or more KBs; provide the plurality of responses to the user device; generate time-to-truth (TTT) instrumentation information associated with providing the plurality of responses to the user device; and provide the TTT instrumentation information to a TTT system. The system also comprises: a TTT system configured to: obtain the TTT instrumentation information from the federated KB computing platform; determine a TTT metric based on the TTT instrumentation information, wherein the TTT metric indicates a parameter for the federated KB computing platform to provide a response, from the plurality of responses, that answers the user query; and provide the TTT metric to the federated KB computing platform, wherein the federated KB computing platform is further configured to update the search vectors associated with the plurality of documents that are stored in the KB metadata and vector database based on the TTT metric and use the updated search vectors to generate one or more subsequent responses to a subsequent user query.

Examples may include one of the following features, or any combination thereof. For instance, in some examples, the system further comprises: a subject matter expert (SME) device configured to: generate certification information for one or more documents from the plurality of documents that are stored in the one or more KBs; provide the certification information to the federated KB computing platform, wherein the KB metadata and vector database of the federated KB computing platform stores metadata for the one or more documents, wherein the metadata comprises the search vectors and the certification information; obtain, from the TTT system, the TTT metric; generate, based on the TTT metric, update information to update a search process for the federated KB computing platform; and provide the update information to the federated KB computing platform.

In some instances, the SME device is further configured to obtain the TTT instrumentation information from the federated KB computing platform, and wherein generating the update information is further based on the TTT instrumentation information.

In some variations, generating the update information comprises generating updated certification information for the one or more documents from the plurality of documents, and wherein the federated KB computing platform is further configured to update the metadata for the one or more documents based on the updated certification information.

In some examples, the SME device is further configured to: obtain SME input indicating to update the search vectors for the one or more documents, wherein the federated KB computing platform is configured to update the search vectors associated with the plurality of documents that are stored in the KB metadata and vector database based on the TTT metric and the SME input.

In some instances, the SME device is further configured to: obtain SME input indicating to update a machine learning-artificial intelligence (ML-AI) search model that was used to generate the plurality of responses, wherein generating the update information is based on the SME input, and wherein the federated KB computing platform is further configured to update the ML-AI search model based on the generated update information prior to generating the one or more subsequent responses to the subsequent user query.

In some variations, generating the plurality of responses comprises: utilizing an artificial intelligence-machine learning (AI-ML) search model and the search vectors to determine the plurality of documents that are responsive to the user query; and generating the plurality of responses based on the plurality of determined documents.

In some instances, the TTT system is further configured to: generate updated parameters for the AI-ML search model based on the TTT metric; and update the AI-ML search model within the federated KB computing platform based on the updated parameters.

In some examples, the TTT instrumentation information comprises user feedback indicating approval or disapproval of one or more documents from the plurality of documents that are indicated by the plurality of responses.

In some variations, the TTT instrumentation information comprises journey information indicating an event log that tracks user interactions with the federated KB computing platform.

In some instances, determining the TTT metric comprises: analyzing the TTT instrumentation information to identify a first time marker of a first user feedback associated with a document from the plurality of documents; determining a second time marker associated with the user device providing the user query; and computing the TTT metric based on the first time marker and the second time marker.

In some examples, determining the TTT metric comprises: processing the TTT instrumentation information using a supervised machine learning-artificial intelligence (ML-AI) model to generate the TTT metric.

In some variations, the TTT system is further configured to: obtain survey information from a plurality of users, wherein the survey information comprises user feedback indicating intents of the plurality of users when the plurality of documents are displayed to the plurality of users; obtaining training TTT instrumentation information comprising training journey information indicating a plurality of event logs that track user interactions with the federated KB computing platform; and training the supervised AI-ML model based on the survey information and the training TTT instrumentation information.

In some examples, determining the TTT metric is based on performing a Bayesian algorithm using a first probability indicating that the response answers the user query and a second probability indicating a user feedback element is selected by a user of the user device.

In another aspect, a method is provided. The method comprises: obtaining time-to-truth (TTT) information associated with a result of a federated knowledge base (KB) computing platform providing a plurality of responses to a user query from a user device of a user, wherein the TTT instrumentation information indicates user feedback information and/or journey information associated with the user query, wherein the plurality of responses indicates a plurality of documents that are stored in one or more KBs, and wherein the federated KB computing platform generates the plurality of responses based on utilizing a KB metadata and vector database that stores search vectors associated with the plurality of documents from the one or more KBs; determining a TTT metric based on the TTT instrumentation information, wherein the TTT metric indicates a parameter for the federated KB platform to provide a response, from the plurality of responses, that answers the user query; and updating the search vectors associated with the plurality of documents that are stored in the KB metadata and vector database based on the TTT metric, wherein the updated search vectors are used to generate one or more subsequent responses to a subsequent user query.

Examples may include one of the following features, or any combination thereof. For instance, in some examples, the user feedback information indicates approval or disapproval of one or more documents from the plurality of documents that are indicated by the plurality of responses and the journey information indicates an event log that tracks user interactions with the federated KB computing platform.

In some instances, determining the TTT metric comprises: analyzing the TTT instrumentation information to identify a first time marker of a first user feedback associated with a document from the plurality of documents; determining a second time marker associated with the user device providing the user query; and computing the TTT metric based on the first time marker and the second time marker.

In some variations, determining the TTT metric comprises: processing the TTT instrumentation information using a supervised machine learning-artificial intelligence (ML-AI) model to generate the TTT metric.

In some instances, determining the TTT metric is based on performing a Bayesian algorithm using a first probability indicating that the response answers the user query and a second probability indicating a user feedback element is selected by the user of the user device.

In yet another aspect, a non-transitory computer-readable medium having processor-executable instructions stored thereon is provided. The processor-executable instructions, when executed, facilitate: obtaining time-to-truth (TTT) information associated with a result of a federated knowledge base (KB) computing platform providing a plurality of responses to a user query from a user device of a user, wherein the TTT instrumentation information indicates user feedback information and/or journey information associated with the user query, wherein the plurality of responses indicates a plurality of documents that are stored in one or more KBs, and wherein the federated KB computing platform generates the plurality of responses based on utilizing a KB metadata and vector database that stores search vectors associated with the plurality of documents from the one or more KBs; determining a TTT metric based on the TTT instrumentation information, wherein the TTT metric indicates a parameter for the federated KB platform to provide a response, from the plurality of responses, that answers the user query; and updating the search vectors associated with the plurality of documents that are stored in the KB metadata and vector database based on the TTT metric, wherein the updated search vectors are used to generate one or more subsequent responses to a subsequent user query.

All examples and features mentioned herein may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3A is a simplified block diagram depicting an exemplary federated knowledge base computing platform in accordance with one or more examples of the present application.

FIG. 3B shows an exemplary certified document snapshot reference in accordance with one or more examples of the present application.

FIG. 3C is a simplified block diagram depicting a relationship between a document database of the federated knowledge base computing platform and the knowledge bases in accordance with one or more examples of the present application.

FIG. 4 is an exemplary process for performing federated knowledge governance for an enterprise organization in accordance with one or more examples of the present application.

FIG. 5 is an exemplary process for performing certification of documents in accordance with one or more examples of the present application.

FIGS. 6A and 6B show an exemplary event sequence for performing federated knowledge governance for an enterprise organization in accordance with one or more examples of the present application.

FIG. 7 is another simplified block diagram depicting an overview of using TTT metric for knowledge management (KM) in accordance with one or more examples of the present application.

FIGS. 8A-8C show an exemplary event sequence for using the TTT metric for KM in accordance with one or more examples of the present application.

FIG. 9 shows an exemplary event log that is based on a user query in accordance with one or more examples of the present application.

FIG. 10 is an exemplary process for using the TTT metric for KM in accordance with one or more examples of the present application.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

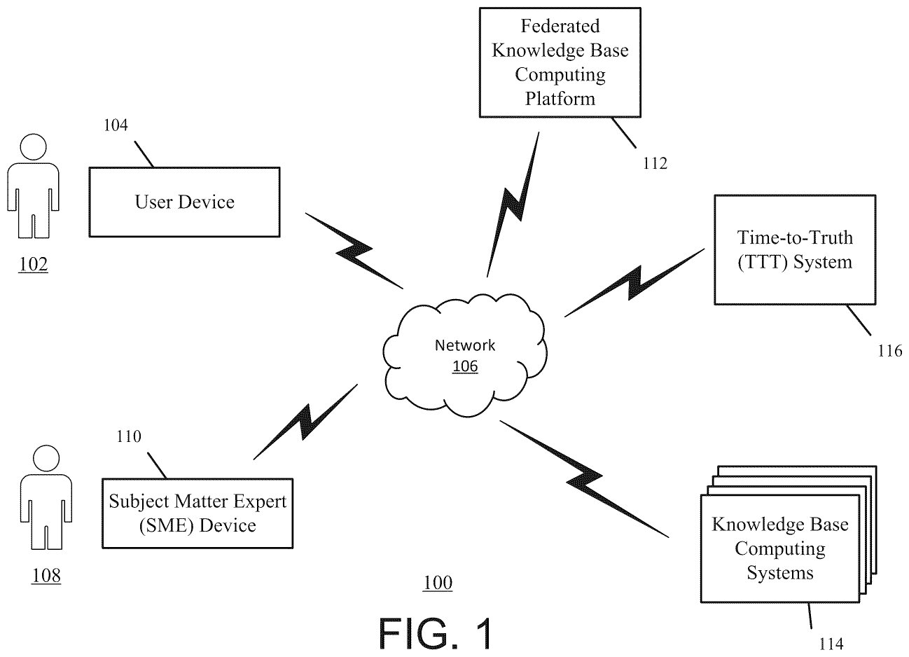

Systems, methods, and computer program products are herein disclosed that utilize a time-to-truth (TTT) metric for knowledge management (KM). FIG. 1 is a simplified block diagram depicting an exemplary environment in accordance with an example of the present application. The environment 100 includes a user 102, a user device 104 (e.g., a computing device), a network 106, a subject matter expert (SME) 108, an SME device 110, a federated knowledge base (KB) computing platform 112, KB computing systems 114, and a TTT system 116. Although the entities within environment 100 may be described below and/or depicted in the FIGs. as being singular entities, it will be appreciated that the entities and functionalities discussed herein may be implemented by and/or include one or more entities. For instance, the federated KB computing platform 112 may include a plurality of computing devices, systems, platforms, repositories, and/or servers that are spread across multiple different geographical locations and communicate with each other using direct connections and/or the network 106.

The entities within the environment 100 such as the user device 104, the SME device 110, the federated KB computing platform 112, the KB computing systems 114, and the TTT system 116 may be in communication with other devices and/or systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100

The user 102 may operate, own, and/or otherwise be associated with the user device 104. For example, the user 102 may seek to access data that is authored, published, certified, controlled, managed, updated, and/or otherwise associated with an enterprise organization. The enterprise organization may be any type of corporation, company, organization, and/or other institution that provides one or more goods and/or services. For instance, the enterprise organization may provide multiple different services such as a grocery pick-up service, a prescription pick-up service (e.g., the enterprise organization may provide prescriptions/medications to a user), an insurance service (e.g., the enterprise organization may provide insurance to a user), a streaming service (e.g., the enterprise organization may provide for streaming videos, television shows, and so on to a user), and/or other services.

The enterprise organization may seek to store data within databases and/or repositories that the enterprise organization owns, manages, and/or is associated with. For example, each work team (e.g., internal departments and/or groups of employees) of the enterprise organization may be responsible for different aspects or tasks. For instance, one work team may provide the prescription pick-up service to users, and another work team may provide insurance services to users. Additionally, and/or alternatively, the work team may include a department such as an HR department or IT department. Each work team may generate (e.g., author) data such as documents (e.g., policy) that facilitate their work flow. The documents may be and/or include any type of static documentation file that is associated with a revision tracking system. For example, the documents may be and/or include, but are not limited to, a text file, a WORD file, a Markdown (md) file, a VISIO diagram file, and/or other types of static documentation files. In some instances, the document may be associated with (e.g., about) an API (e.g., a confluence document describing API endpoints, behavior, usage, patterns, and so on).

For example, the HR department may generate/author/manage data such as policy documents for a vacation policy for employees and/or travel policies for employees. In another example, the IT department may generate/author/manage data such as policy documents for security policies (e.g., Internet websites that are unauthorized or software applications that an employee are not allowed to download onto their work computers). In yet other examples, a work team may generate/author/manage projects (e.g., APIs and/or software applications such as a tax calculator API that may be used to calculate taxes for individuals). The work team may generate documents such as md files to describe the project.

The user 102 may seek to access data associated with an enterprise organization. For example, the user 102 may be an employee of the enterprise organization and may seek to access the vacation policy that was authored by the HR department, may seek to access documentation regarding a project (e.g., an md file associated with the tax calculator API). As such, using the user device 104, the user 102 may provide a request to the federated KB computing platform 112 to access the data.

The user device 104 is and/or includes, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The user device 104 may be able to execute software applications and/or programs. Additionally, and/or alternatively, the user device 104 may be configured to operate a web browser to connect to a web page and/or applications.

The KB computing systems 114 are KBs that are associated with the enterprise organization. For example, each work group may generate data (e.g., policy documents, md files, and/or other documents) that is associated with their individual work flow. For instance, the HR department may author policies such as vacation policies for employees of the enterprise organization, and another work team may author documents about one or more APIs/software applications that the team is currently developing and/or managing. The KB computing systems 114 may store the data that is authored by the different work teams. The enterprise organization may include numerous different work teams, and each KB computing system 114 may be associated with one or more of the work teams. For instance, the work team may generate data (e.g., author documents associated with a tax calculator API and/or software applications), and store the generated data within a KB computing system 114 that is owned, managed, and/or associated with the work team.

The KB computing systems 114 include and/or are implemented using one or more computing devices, computing platforms, cloud computing platforms, systems, servers, repositories, databases, and/or other apparatuses. For instance, in some examples, the KB computing systems 114 may be a set of repositories and/or databases that store data for the different work teams of the enterprise organization. In other examples, the KB computing systems 114 may further include one or more computing devices that the work teams may use to generate the data (e.g., author the documents). In some examples, the KB computing systems 114 may be implemented as engines, software functions, and/or applications. In other words, the functionalities of the KB computing systems 114 may be implemented as software instructions stored in storage (e.g., memory) and executed by one or more processors.

The federated KB computing platform 112 is a computing platform that is configured to perform federated knowledge governance. For example, based on a request from the user device 104, the federated KB computing platform 112 may provide access to the requested data from the KB computing systems 114. For example, the request from the user device 104 may be to review a travel policy implemented by the enterprise organization. The federated KB computing platform 112 may provide information indicating the travel policy to the user device 104. For instance, the work team (e.g., the HR department) may prepare a certified version of the travel policy (e.g., a version of the travel policy that is currently being implemented by the enterprise organization). Furthermore, the work team may continue to work on the travel policy (e.g., providing updates that have not been approved and/or certified). As such, the KB computing system 114 associated with the work team may store multiple versions of the travel policy including the latest version as well as the certified version. A user 102 might not care about the latest version of the travel policy that has not been certified and/or implemented, and instead is requesting the certified version. Thus, based on a request, the federated KB computing platform 112 may provide the certified version of the travel policy to the user 102. For example, the federated KB computing platform 112 may store snapshot references of data from the KB computing systems 114, such as snapshot references of the certified and/or uncertified versions of the data. The snapshot references may include and/or indicate identifiers indicating a storage location of the data, and the identifiers may be and/or include links, deep links, and/or other identifiers that indicate where the data is stored within the KB computing systems 114. For instance, the federated KB computing platform 112 may store a snapshot reference of the certified version of the travel policy. Using the snapshot reference, the federated KB computing platform 112 may retrieve the travel policy from the KB computing system 114 and provide the travel policy to the user device 104. Additionally, and/or alternatively, the federated KB computing platform 112 may provide the snapshot reference and/or identifier to the user device 104, and the user device 104 may access the document using the snapshot reference.

In some examples, the user 102 may request access to another type of document such as an md file associated with a project. For instance, the work team may work on one or more projects and prepare documentation to describe the project. Similar to the above, the work team may store multiple versions of the md file for the project in KB computing system 114, including a latest version of the md file and a certified version of the md file, which may or may not be the same version.

The federated KB computing platform 112 includes and/or is implemented using one or more computing devices, computing platforms, cloud computing platforms, systems, servers, databases, repositories, and/or other apparatuses capable of performing federated knowledge governance. In some examples, the federated KB computing platform 112 may be implemented as engines, software functions, and/or applications. In other words, the functionalities of the federated KB computing platform 112 may be implemented as software instructions stored in storage (e.g., memory) and executed by one or more processors.

In some examples, the work team may seek certify data (e.g., the documents such as the policy documents). An SME 108 may use an SME device 110 to certify the data. For example, a document may be “certified” when the document is asserted to be valid and canonical for a specified period of time by an expert (e.g., SME 108) that is empowered to certify documents in a given domain. In other words, the certification process may be domain-specific. Thus, for example, the HR lead may be an SME 108 that certifies an HR policy document for a period of time (e.g., from Jan. 1, 2024 to Jan. 1, 2025), and for that period of time, the certified version of the document may be considered definitive. A document may be de-certified early (e.g., if the policy changes early) or re-certified again for a subsequent time period (e.g., if the policy does not change).

In some instances, the SME device 110 may communicate directly with the KB computing system 114 to certify the data. For example, the SME 108, using the SME device 110, may certify the documents such as the policy documents. In other instances, the SME device 110 may communicate with the federated KB computing platform 112 to certify the data within the KB computing systems 114. The certification process will be described in further detail below.

The SME device 110 is and/or includes, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The SME device 110 may be able to execute software applications and/or programs. Additionally, and/or alternatively, the SME device 110 may be configured to operate a web browser to connect to a web page and/or applications.

The TTT system 116 is a system that is configured to determine TTT metric and use the TTT metric for KM. For example, based on a request from the user device 104, the federated KB computing platform 112 may obtain information (e.g., TTT instrumentation information) associated with the request such as user feedback information (e.g., user quality feedback) and/or journey information. The user feedback information may be based on user input from the user 102 (e.g., a thumbs up or a thumbs down indicating relevance of the results from the federated KB computing platform 112). The journey information may indicate data associated with the user 102 reviewing the results (e.g., a time duration or length that the user 102 reviewed a particular document from the results). The TTT system 116 may obtain the journey information and/or the user feedback information, and determine TTT metric based on the journey information and/or the user feedback information. The TTT metric may be a systemic metric that measures the holistic quality of KBs (e.g., KB computing systems 114). For instance, the TTT metric may represent a time to truth (e.g., an indicator or metric) for a user 102 engaging with the federated KB computing platform 112 to obtain results that sufficiently respond to their query. For example, the TTT metric may indicate a time until the user 102 obtains a sufficient answer to their query. In other words, the TTT system 116 may be configured to track the quality of knowledge both in document terms (e.g., the relevance of the document to the user's query) and relational terms (e.g., whether the document is fit for the user's query). To measure the quality of knowledge of the federated KB computing platform 112 and/or the KB computing systems 114, the TTT system 116 generates a TTT metric, which may be and/or indicate a primary key-performance indicator (KPI) for the federated KB computing platform 112 and/or the KB computing systems 114.

Subsequently, the TTT system 116 may utilize the TTT metric for KM. For example, based on the TTT metric, the instrumentation of the knowledge discovery process may be updated. For instance, a search system associated with the federated KB computing platform 112 may be updated. Additionally, and/or alternatively, the search system may use a machine learning-artificial intelligence (ML-AI) model or algorithm such as a retrieval-augmented generation (RAG) AI model. Based on the TTT metric, the ML-AI model such as the RAG AI model may be updated and/or improved further. Additionally, and/or alternatively, one or more documents may be certified by one or more subject matter experts (SMEs). The TTT system 116 may provide the TTT metric to the SME 110. Based on the TTT metric, the SME 110 may provide SME information back to the TTT system 116 and/or the federated KB computing platform 112. For example, the SMEs may review the distinction between user intent and document intent and determine whether to update the metadata associated with the document. The TTT system 116, the generation of the TTT metric, and the use of the TTT metric for KM will be described in further detail below.

The TTT system 116 includes and/or is implemented using one or more computing devices, computing platforms, cloud computing platforms, systems, servers, databases, repositories, and/or other apparatuses capable of determining TTT metric and using the TTT metric for KM. In some examples, the TTT system 116 may be implemented as engines, software functions, and/or applications. In other words, the functionalities of the TTT system 116 may be implemented as software instructions stored in storage (e.g., memory) and executed by one or more processors.

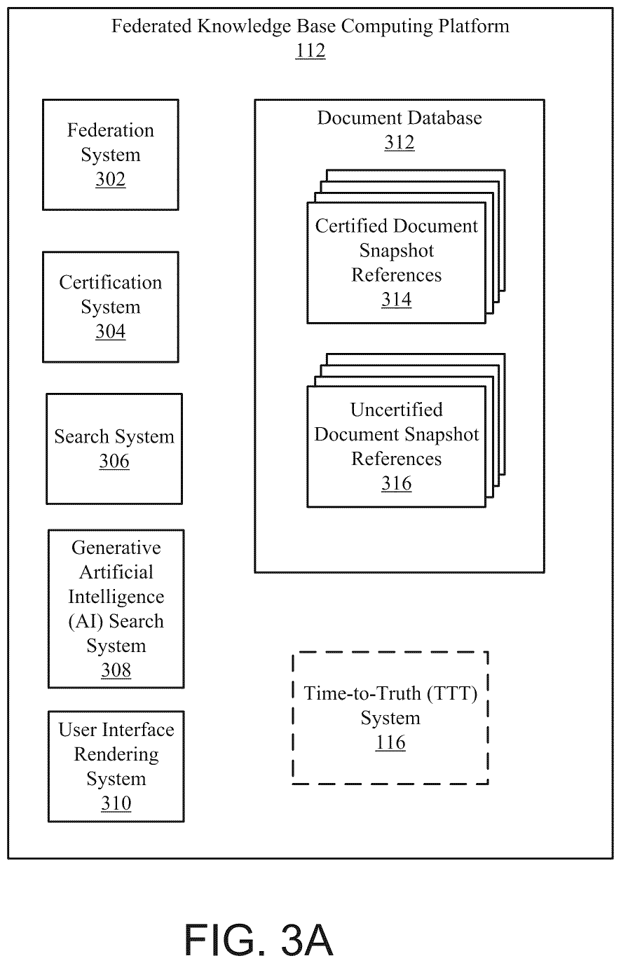

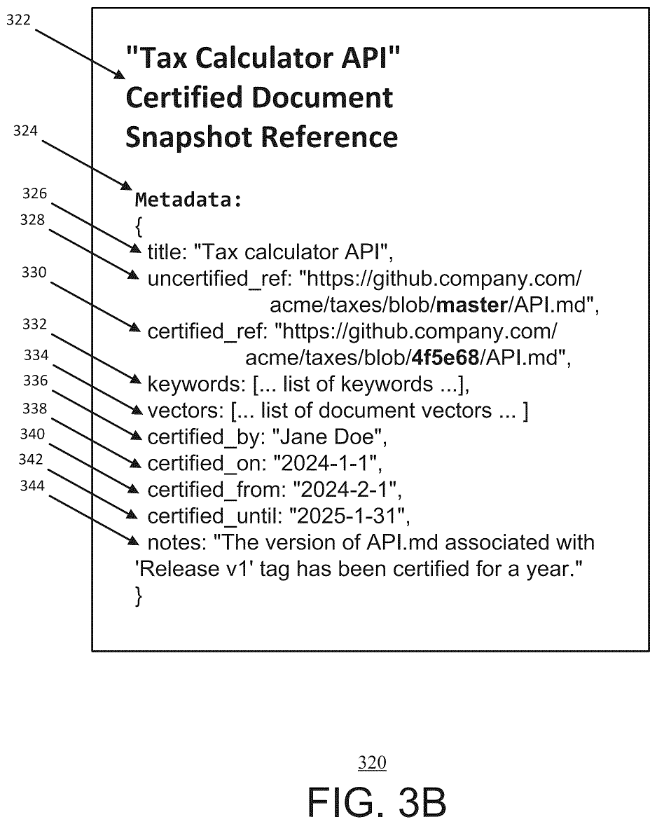

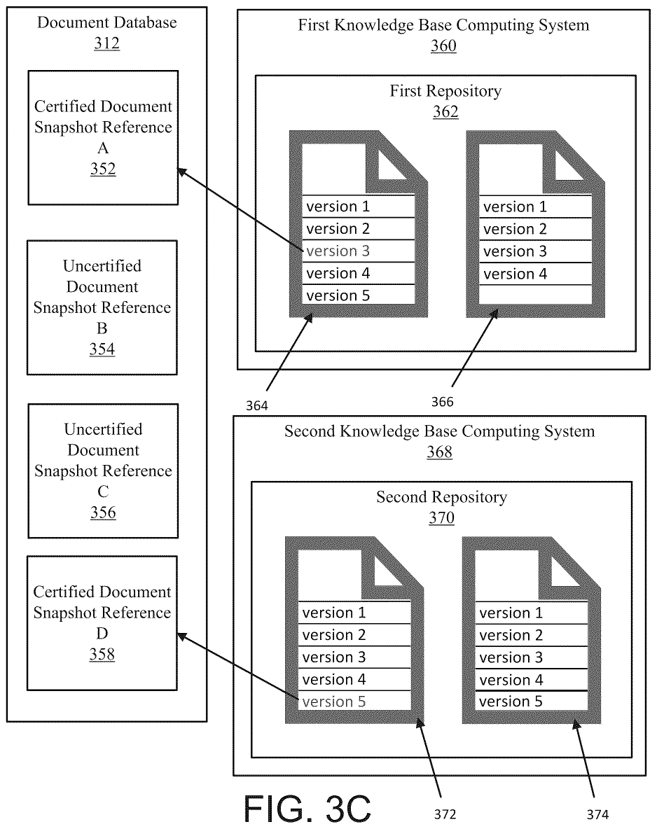

It will be appreciated that the exemplary environment depicted in FIG. 1 is merely an example, and that the principles discussed herein may also be applicable to other situations—for example, including other types of institutions, organizations, devices, systems, and network configurations. For example, in some variations, the functionalities of the federated KB computing platform 112 may be separated into multiple different entities, which is described in further detail in FIGS. 3A-3C below. Additionally, and/or alternatively, as is shown in FIG. 3A below, the TTT system 116 may be included within the federated KB computing platform 112. In other words, the federated KB computing platform 112 may be configured to perform the functionalities of the TTT system 116 (e.g., determine TTT metric and use the TTT metric for KM).

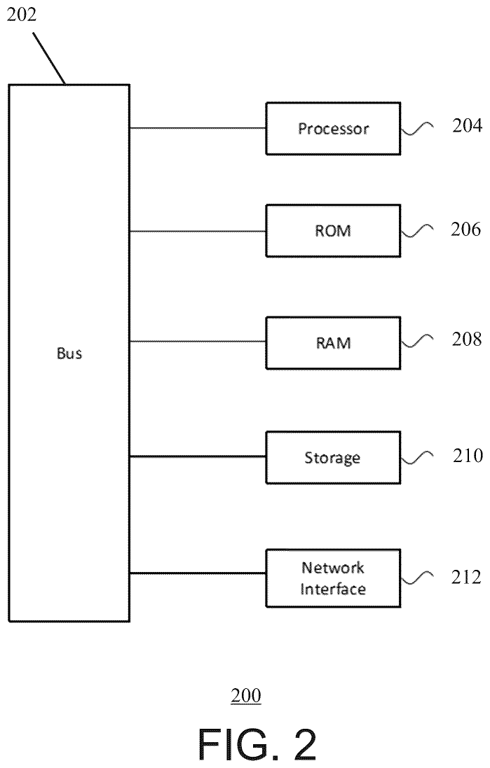

FIG. 2 is a block diagram of an exemplary system and/or device 200 within the environment 100. The device/system 200 includes one or more processors 204, such as one or more CPUs, controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

FIG. 3A is a simplified block diagram depicting an exemplary federated KB computing platform 112 in accordance with one or more examples of the present application. The federated KB computing platform 112 includes a federation system 302, a certification system 304, a search system 306, a generative artificial intelligence (AI) search system 308, a user interface rendering system 310, a document database 312, and an optional TTT system 116. The document database 312 includes certified document snapshot references 314 and uncertified document snapshot references 316. Each of the federation system 302, the certification system 304, the search system 306, the generative AI search system 308, the user interface rendering system 310, and/or the document database 312 may include one or more computing systems, devices, apparatus, servers, databases, repositories, and/or other entities that are configured to perform one or more functionalities for the enterprise organization.

For instance, the federation system 302 (e.g., a federation engine) may be configured to locate and/or access a given document repository, list/find/retrieve documents from the document repository, parse the document history to determine versions of the document, and/or create deep links to the different versions of the document. For instance, the federated system 302 may include (e.g., track and/or store) a list of federated document repositories, and may further include information associated with each of the repositories such as a specific type of repository (e.g., whether the document repository is a SHAREPOINT repositories, GITHUB repositories, MEDIAWIKI instances, and/or other types of repositories) and/or configuration information of the repository. For instance, the type of repository may be associated with a particular code module, which may “know” how to track and reference documents on a given document storage platform, how to parse and construct valid deep links, and so on. For example, GITHUB repositories may use a uniform resource locator (URL) (e.g., a GIT URL) that includes document global unique identifiers (GUID) within a deep link. Thus, a system may have to actually parse the repository history to determine which version of the document is associated with the deep link. Therefore, the federation system 302 may include a GIT module that is configured to parse the revision history, including multiple branches/tags and their splits/merges, and associate it with blob deep links. In another example, MEDIAWIKI may directly embed versions within the URL. Thus, the federation system 302 may include a MEDIAWIKI module that is configured to scan the document revision history and extract deep links from it directly.

Therefore, in some examples, the federated system 302 may be configured to locate and access a given document repository. Following, the federated system 302 may list, find (e.g., determine), and/or retrieve documents from the given document repository. Further, the federated system 302 may parse the document history of the document and/or create deep links to a specific historical version of the document. In other words, in some variations, the federated system 302 may find, access (e.g., using properly authorized credentials and/or another access method), and/or process information in the documentation repository. Additionally, and/or alternatively, the federated system 302 may include configuration information, such as configuration information associated with the repository URL (repo URL), type of repository (e.g., GITHUB repository and/or MEDIAWIKI instances), credentials, and/or additional metadata to facilitate processing such as the document tagging scheme and/or folder structure.

The certification system 304 (e.g., certification engine) may be configured to facilitate the certification process for data (e.g., documents) within the KB computing systems 114. For example, as mentioned above, in some variations, the SME device 110 may communicate directly with the KB computing systems 114 to certify the data/documents. In other variations, the SME device 110 may communicate with the certification system 304 to facilitate the certification of the documents. For example, the certification system 304 may provide a request to the SME device 110 to certify a document. The SME device 110, using the certification system 304 and/or based on directly communicating with the KB computing systems 114, may retrieve a list of versions of the document from the KB computing systems 114, and identify a version that is suitable for certification (e.g., the latest version is suitable for certification). The SME device 110 may provide an indication to the certification system 304 indicating validation of the document and/or additional information. Additionally, and/or alternatively, the certification system 304 may generate metadata associated with the validation such as the SME 108 that certified document, the certification date and how long the document is certified for, and/or other notes/information (e.g., based on the additional information provided by the SME device 110).

The search system 306 and the generative AI search system 308 may perform a search for data requested by the user device 104. For example, the user device 104 may provide a request to the federated KB computing platform 112 to access a document that is stored in the KB computing systems 114. The search system 306 and/or the generative AI search system 308 may be used to fulfill the request. For instance, the search system 306 may use one or more searching methods, processes, and/or algorithms to search the document database 312 for a document snapshot reference (e.g., a certified document snapshot reference 314) that fulfills the request. For example, the request from the user device 104 may indicate a travel policy. The search system 306 may search the document database 312 for a snapshot reference for the travel policy. The generative AI search system 308 may function similarly to the search system 306 except that the generative AI search system 308 may use generative AI to perform the search of the document database 312 for the snapshot reference. Subsequently, the search system 306 and/or the generative AI search system 308 may provide the retrieved snapshot reference back to the user device 104, and the user device 104 may use the snapshot reference to access the document from the KB computing systems 114.

In some examples, instead of the providing the retrieved snapshot reference to the user device 104, the federated KB computing platform 112 may retrieve the actual document (e.g., the md file and/or the travel policy) from the KB computing systems 114. For example, the user interface (UI) rendering system 310 may render a UI for the user device 104. For instance, the UI rendering system 310 may render a UI for the user device that includes the retrieved document from the KB computing system 114 as well as incorporating other aspects such as navigation, search, common styling, branding, and/or other UI features. In other words, in some variations, the UI rendering system 310 may cause display of a UI on the user device 104 based on the request, and the UI may include the requested document and other features and/or aspects.

The document database 312 may be one or more databases and/or repositories that store snapshot references for the enterprise organization. For instance, the document database 312 may store certified document snapshot references 314 and/or uncertified document snapshot references 316 indicating storage locations of the actual documents within the KB computing system 114. For example, after a document version has been authored and registered with the KB computing system 114. The federated KB computing platform 112 (e.g., the federation system 302 and/or the certification system 304) may receive an indication of the new document version, and store a snapshot reference to the new document version into the document database 312. Initially, the snapshot reference to the new document version may be an uncertified document snapshot reference 316. Then, using the certification system 304, the SME 108 may certify the new document version, and the federated KB computing platform 112 may receive an indication the certification. The federated KB computing platform 112 may register the uncertified document snapshot reference 316 as a certified document snapshot reference 314. An example of the snapshot reference and the relationship between the snapshot references and the KB computing systems 114 will be described in further detail in FIGS. 3B and 3C.

In addition, in FIG. 3A, the TTT system 116 is shown as a dotted box to denote that the TTT system 116 may be optionally included within the federated KB computing platform 112. For example, in some instances such as the environment 100 of FIG. 1, the TTT system 116 and the federated KB computing platform 112 may be separate entities. In other instances, the federated KB computing platform 112 may include the TTT system 116 that is shown in FIG. 1. The functionality of the TTT system 116 is shown and described in further detail below.

FIG. 3B shows an exemplary certified document snapshot reference 320 in accordance with one or more examples of the present application. For example, FIG. 3B shows a snapshot reference 320 for a document (e.g., md file) associated with a Tax Calculator API. The header 322 of the snapshot reference 320 indicates that the snapshot reference 320 is for a “Tax Calculator API”, and that the snapshot reference 320 is a “Certified Document Snapshot Reference.” The snapshot reference 320 further includes metadata 324. The metadata 324 includes a title 326 for the document, which as shown is “Tax calculator API.” The metadata 324 further includes identifiers including an uncertified identifier 328 (e.g., “uncertified ref”) and a certified identifier 330 (e.g., “certified_ref”). As mentioned above, the identifiers 328 and 330 may be, in some examples, deep links that indicate storage locations of the actual documents within the KB computing systems 114. The metadata 324 may further include keywords 332 and/or vectors 334 that are associated with the document, and the search system 306 and/or the generative AI search system 308 may search for the requested document snapshot reference using the keywords 332 and/or vectors 334. For instance, the keywords 332 may be used for traditional keyword search (e.g., using the search system 306). The vectors 334 may be used by the generative AI search system 308. The metadata 324 may further include certification information 336-342 associated with the certification of the document. The certification information may include a name 336 of an SME 108 that certified the document (e.g., “Jane Doe”), a date of certification 338 such as “2024-1-1,” and a duration of the certification 340-342 (e.g., certified from “2024-2-2” to “2025-1-31”). Further, the certification information may include notes 334 that may be provided by the SME 108, the SME device 110, and/or others. The snapshot reference 320 is merely an example, and in other variations, a snapshot reference may include additional and/or alternative information.

In some examples, using the identifiers 328 and/or 330, the federated KB computing platform 112 and/or the user device 104 may access the requested data. For example, the identifier 328 may indicate a “master” API Markdown (md) file associated with the Tax Calculator API, and the “master” API md file may be an uncertified version of the document. The identifier 330 may indicate a certified version of the md file that is stored within the KB computing system 114. For example, the KB computing system 114 may store multiple versions of a document (e.g., API md files for the Tax calculator service), and each version may be associated with an identification such as “1a2b3c,” “2d3e4f,” “4f5e68,” and “7df9a2.” The versions may be “initial commit” versions, “pre-release” versions, and/or “release” versions. Currently, the certified version may be the “release version” that is indicated by the identification “4f5e68.” Thus, the identifier 330 may indicate a certification version of the document (e.g., API md), which is identified within the KB computing system 114 using the identification “4f5e68.”

FIG. 3C is a simplified block diagram depicting a relationship between a document database of the federated knowledge base computing platform and the knowledge bases in accordance with one or more examples of the present application. For instance, FIG. 3C shows the document database 312 as well as two KB computing systems 114 (e.g., the first KB computing system 360 and the second KB computing system 368). Each of the KB computing systems 360 and 368 include repositories 362 and 370 (e.g., a first and second repository 362 and 370).

As shown, the document database 312 includes certified and uncertified snapshot references. For example, the document database 312 includes a certified document snapshot reference A 352, an uncertified document snapshot reference B 354, an uncertified document snapshot reference C 356, and a certified document snapshot reference D 358. Furthermore, the KB computing systems 360 and 368 include repositories 362 and 370 that show the actual storage of each of the versions of the documents. For example, the first repository 362 may store document A 364 and document B 366. Further, as shown, the first repository 362 may store five versions of document A 364 and four versions of document B 366. In addition, the third version of document A 364 may be the certified version, and no version of document B 366 may be certified. Thus, the certified document snapshot reference A 352 may include metadata and/or an identifier that indicates a storage location of a third version of document A 364 within the first repository 362 (e.g., the first repository 362 that stores the certified version of document A 364). Further, the uncertified document snapshot reference B 354 may include an identifier that indicates that a storage location of the latest version of document B 366 (e.g., the first repository 362 that stores version four of document B 366).

Similarly, the document database 312 may store certified and uncertified snapshot references for multiple different KB computing systems 114 such as the second knowledge base computing system 368. For example, the uncertified document snapshot reference C 356 may include an identifier indicating a storage location (e.g., the second repository 370) for the document C 374. The certified document snapshot reference D 358 may include an identifier indicating a storage location (e.g., the second repository 370) for the document D 372. Further, the identifier of the uncertified document snapshot reference C 356 may be the latest version of document C 374, which might not be certified. For instance, as shown, the document C 374 may include five versions and an SME 108 might not have certified any of the versions at this time. The identifier of the certified document snapshot reference D 358 may be the latest version of document D 372, which may also be certified version of document D 372. For example, in some instances, the latest version of a document that is stored within the KB computing systems 114 may also be the certified version of the document.

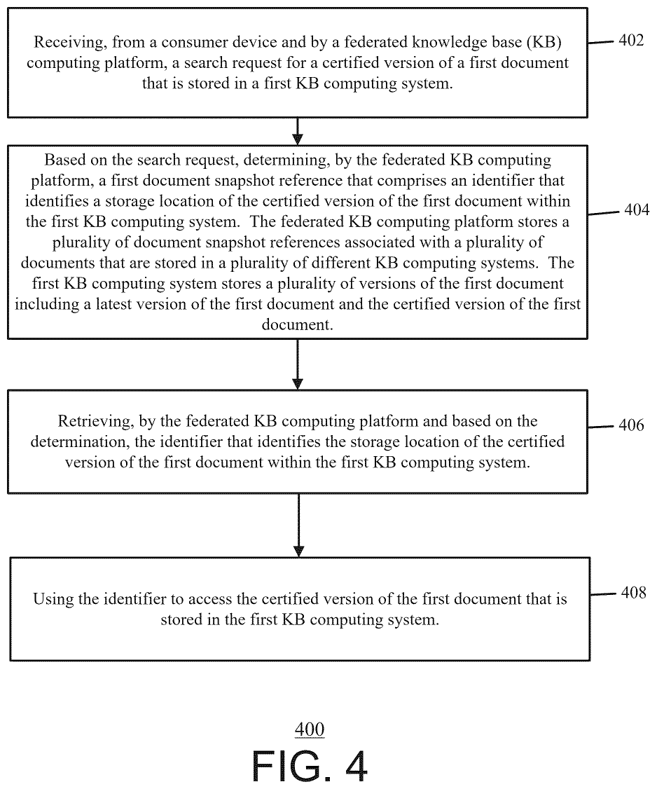

FIG. 4 is an exemplary process for performing federated knowledge governance for an enterprise organization in accordance with one or more examples of the present application. One or more blocks from process 400 may be performed by the federated KB computing platform 112 and/or the user device 104 of environment 100 shown in FIG. 1. It will be recognized that any of the following blocks may be performed in any suitable order, and that the process 400 may be performed in any suitable environment. The descriptions, illustrations, and processes of FIG. 4 are merely exemplary and the process 400 may use other descriptions, illustrations, and processes for performing federated knowledge governance for an enterprise organization.

At block 402, the federated KB computing platform 112 receives, from a user device 104, a search request for a certified version of a first document that is stored in a first KB computing system. The first KB computing system may be one of a plurality of KB computing systems 114. For example, as mentioned above, the user 102 may use the user device 104 to request a document (e.g., a certified version of the document) that is stored in one of the KB computing systems 114 of the enterprise organization. For instance, authors may generate data such as documents, including multiple versions of the documents, and store the documents into one of the plurality of KB computing systems 114. Further, an SME 108 may certify one of the versions of the documents. In some examples, the certified version of the document might not be the latest version of the document. For example, an SME 108 may certify a document associated with a release (e.g., a 1.0 release of a software application/API). However, the author may continue to work on the document even after release. But, the continued work on the document might not be certified by the SME 108 until stability is achieved. As such, the KB computing system 114 (e.g., the first KB computing system) may store multiple versions of the documents, including a latest version of the document and a certified version of the document, and the latest and certified versions of the document may be the same version of the document, but may also be different versions of the document. At block 402, the federated KB computing platform 112 receives a request for a certified version of a first document, which may or might not be the latest version of the document.

At block 404, based on the search request, the federated KB computing platform 112 determines a first document snapshot reference that comprises an identifier that identifies a storage location of the certified version of the first document within the first KB computing system. The federated KB computing platform stores a plurality of document snapshot references associated with a plurality of documents that are stored in a plurality of different KB computing systems. The first KB computing system stores a plurality of versions of the first document including a latest version of the first document and the certified version of the first document.

For example, referring back to FIGS. 3A-3C, the federated KB computing platform 112 may include a document database 312 that stores multiple different certified and uncertified document snapshot references 314 and 316. The snapshot references (e.g., snapshot reference 320) may indicate a storage location of a version of a document. Based on the search request, the federated KB computing platform 112 may determine a snapshot reference associated with the search request. For example, the federated KB computing platform 112 may determine that the user 102 is requesting document A 364, and determine the snapshot reference 352 indicating a storage location of a certified version of the document A 364 (e.g., the third version that has been certified). As shown in FIG. 3C, the certified version of document A 364 is not the latest version of document A 364 (e.g., the third version is certified and the latest version is the fifth version). In other examples, such as if the user 102 is requesting document D 372, the latest version of the document D 372 may be the same as the certified version (e.g., both of them may be version five). The federated KB computing platform 112 may determine the certified document snapshot reference associated with the requested document (e.g., the certified document snapshot reference A 352 associated with the requested document 364), and retrieve the snapshot reference from the document database 312. In some examples, as mentioned above, the federated KB computing platform 112 may use the search system 306 and/or the generative AI search system 308 to determine the certified document snapshot reference that is associated with the search request from the user device 104.

At block 406, the federated KB computing platform 112 retrieves, based on the determination from block 404, the identifier that identifies the storage location of the certified version of the first document within the first KB computing system. For example, based on determining a certified document snapshot reference (e.g., the certified document snapshot reference A 352) associated with document A 364 that is within the first repository 362 of the first knowledge base computing system 360, the federated KB computing platform 112 may retrieve the certified document snapshot reference. As mentioned in FIG. 3B, the certified document snapshot reference may include identifiers 328 and 330, including an identifier 330 indicating a storage location of the certified version of the document (e.g., a deep link indicating the certified version of the document). In some examples, the federated KB computing platform 112 may retrieve the entire certified document snapshot reference. In other examples, the federated KB computing platform 112 may retrieve only the text associated with the identifier 330 (e.g., the deep link indicating the storage location of the certified version of the document).

At block 408, the federated KB computing platform 112 and/or the user device 104 may use the identifier to access the certified version of the first document that is stored in the first KB computing system. In some examples, after retrieving the identifier (e.g., identifier 330), the federated KB computing platform 112 may provide the identifier to the user device 104. Then, at block 408, the user device 104 may use the identifier (e.g., deep link) to access the certified version of the document. For example, using the deep link, the user device 104 may access the document A that is stored in the first repository 362 of the first knowledge base computing system 360.

In other examples, the federated KB computing platform 112 may include the UI rendering system 310, and may render a UI for the user device 104. For example, at block 408, the federated KB computing platform 112 may access (e.g., retrieve) the version of the document indicated by the identifier (e.g., retrieve version three of the document A 364 that is indicated by the determined certified document snapshot reference A 352). For instance, the federated KB computing platform 112 may provide a request to a KB computing system 114, and the request may include the identifier. The KB computing system 114 may retrieve the certified version of the first document using the identifier, and provide the certified version of the first document to the federated KB computing platform 112. After, using the UI rendering system 310, the federated KB computing platform 112 may render a UI for the user device 104 that displays the requested document as well as other features (e.g., navigation, search, common styling, branding, and/or other UI features). The user 102 may review the requested document (e.g., the certified version of the document) on the UI that is displayed on the user device 104.

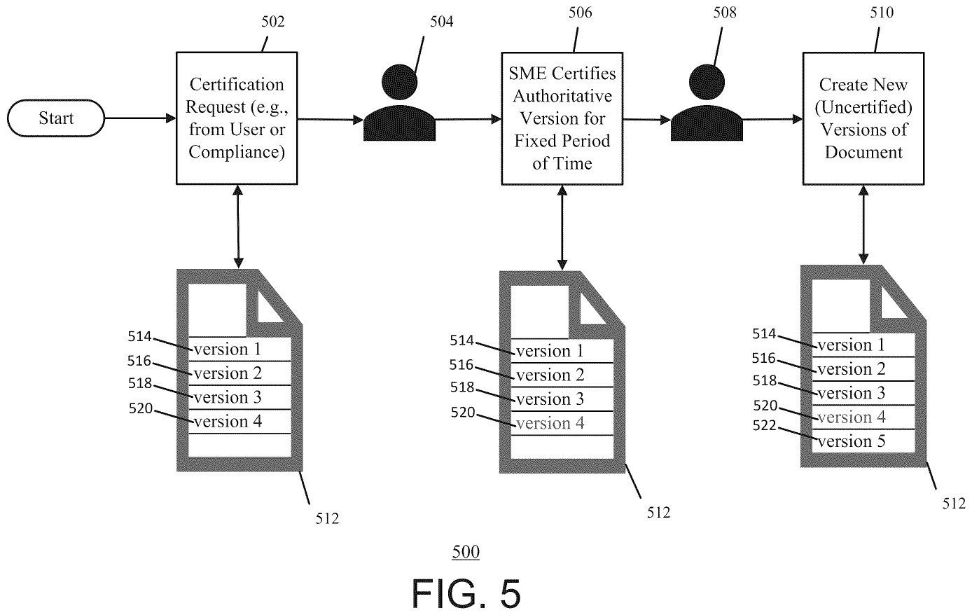

FIG. 5 is an exemplary process 500 for performing certification of documents in accordance with one or more examples of the present application. The process 500 may be performed by one or more entities of environment 100 shown in FIG. 1. It will be recognized that any of the following blocks may be performed in any suitable order, and that the process 500 may be performed in any suitable environment. The descriptions, illustrations, and processes of FIG. 5 are merely exemplary and the process 500 may use other descriptions, illustrations, and processes for performing federated knowledge governance for an enterprise organization.

For example, FIG. 5 shows process 500 including blocks 502-510 for authoring and certifying versions of documents. Further, similar to FIG. 3C, the versions for a document 512 at different stages of the certification process 500 are shown. For instance, initially, at block 502, a certification request (e.g., from a user or compliance) is provided. For example, a document 512 may include a plurality of versions such as the four versions 514-520. Each version of the document 512 may be stored within a KB computing system 114. Initially, at block 502, none of the versions 514-520 of the document 512 may be certified.

At block 504, the SME 108, using the SME device 110, may identify the authoritative version. For example, the SME device 110 may retrieve all versions 514-520 of the document 512 and identify the authoritative version of the document based on a review.

At block 506, the SME 108, using the SME device 110, certifies the authoritative version of the document for a fixed period of time (e.g., for the next year). For example, the SME device 110 may provide an indication that the fourth version 520 of the document 512 is certified. As such, at block 506, one of the versions of the document 512 (e.g., the fourth version 520) is certified. In some examples, the SME 108, using the SME device 110, may certify the latest version of the document. In other examples, the SME 108, using the SME device 110, may certify a version of the document that is not the latest version of the document. For example, the SME device 110 may provide a certification indication to the federated KB computing platform 112 to certify a version of the document that is not the latest version of the document. Then, the federated KB computing platform 112 may generate a document snapshot reference based on the certification indication from the SME device 110.

At block 508, an author, using an authoring device (e.g., an authoring device that is part of the KB computing system 114 that stores the versions 514-520 of the document 512 and/or that is separate from the KB computing system 114), may continue to edit the document 512.

By continuing to edit the document 512, at block 510, the author, using the authoring device, may author another version 522 of the document 512. This new version might not be certified by the SME 108 at block 510. However, process 500 may repeat, and in the next iteration, the SME 108 may certify this new version 522 of the document 512 instead, and the version 520 of the document 512 may be retired.

During and/or following the process 500, process 400 may be performed and the user 102 may seek to access a version of the document. The federated KB computing platform 112 may provide the certified version of the document (e.g., the fourth version 520 of the document 512) based on the request from the user device 104.

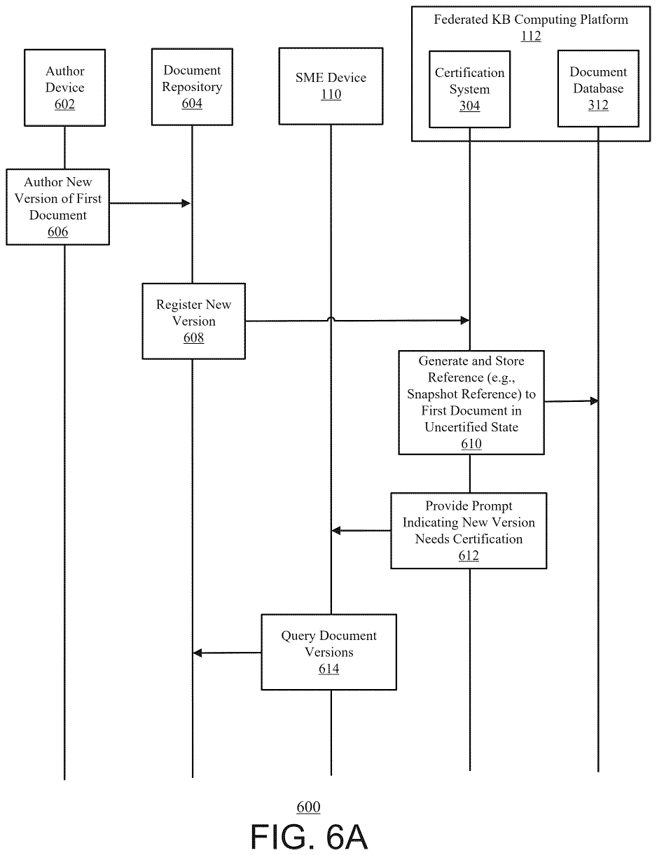

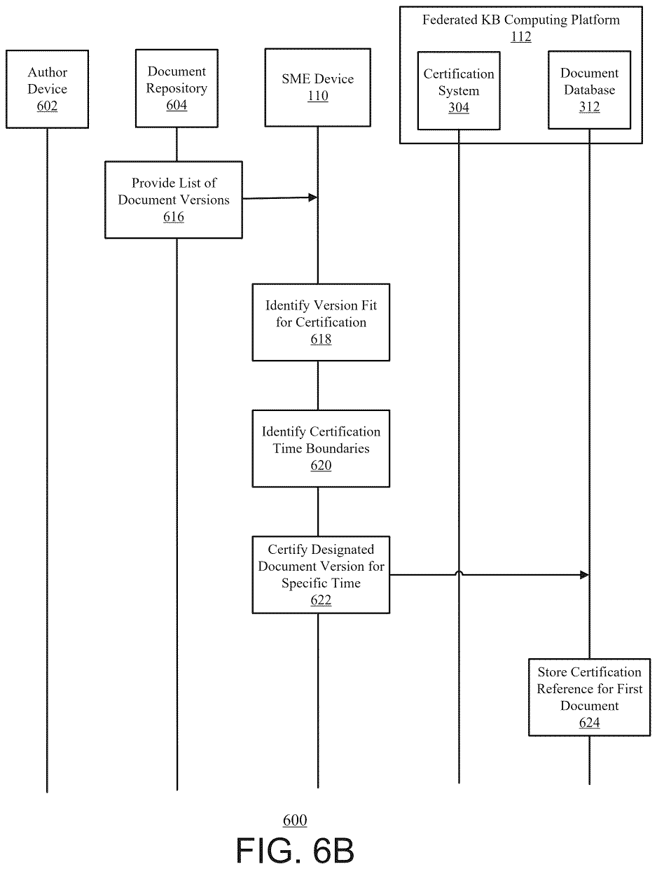

FIGS. 6A and 6B show an exemplary event sequence 600 for performing federated knowledge governance for an enterprise organization in accordance with one or more examples of the present application. However, the event sequence 600 is merely an example and other types of event sequences are contemplated herein including by performing any of the following blocks in any suitable order. The event sequence 600 includes operations, processes, and/or functions that are performed by one or more entities. For example, the event sequence 600 includes blocks performed by an author device 602, a document repository 604, an SME device 110, and a federated KB computing platform 112, which includes a certification system 304 and a document database 312. As mentioned previously, the KB computing systems 114 may include databases and/or repositories such as the document repository 604. Additionally, and/or alternatively, the KB computing systems 114 may include the author device 602 (e.g., a device for an author to generate a document). In some examples, the author device 602 may be separate from the KB computing systems 114.

In operation, at block 606, the author device 602 authors a new version of a first document. For example, as described above, a KB computing system 114 may include a repository (e.g., document repository 604) that stores documents, including one or more versions of the document. The stored versions of the document may include a certified version and a latest version, which may or may not be the same version. In some instances, prior to block 606, the document repository 604 may already store one or more versions of the first document, and at block 606, the author device 602 may author a new version of the first document. This new version may be uncertified at this point. In other instances, the document repository 604 might not store any versions of the first document. At block 606, the author device 602 may author a new and first version of the first document, and store the first version in the document repository 604.

At block 608, the document repository 604 (e.g., the KB computing system 114) registers the new version. For example, after receiving the new version of the first document and storing the new version in memory, the document repository 604 may seek to register the new version with the federated KB computing platform 112 (e.g., the certification system 304). To register the new version, the document repository 604 may provide information (e.g., a registration request) to the federated KB computing platform 112.

At block 610, the certification system 304 generates and stores, in the document database 312, a reference (e.g., snapshot reference) to the first document in an uncertified state. For example, referring back to FIG. 3A, the document database 312 may store certified document snapshot references 314 and uncertified document snapshot references 316. Here, given that the new version of the document that was authored at block 606 has not been certified, the certification system 304 may generate an uncertified document snapshot reference 316 for the new version. In some examples, the uncertified document snapshot reference 316 may include metadata that indicates an identifier (e.g., identifier 328 from FIG. 3B) that indicates a storage location of the new version of the document and/or other information (e.g., author information from an author). For instance, when registering the new version at block 608, the document repository 604 may provide an identifier (e.g., a deep link) that indicates the storage location of the new version of the document that was authored at block 606. The certification system 304 may generate a snapshot reference that includes this identifier and store the generated snapshot reference into the document database 312.

At block 612, the certification system 304 provides a prompt to the SME device 110 indicating that the new version needs certification. For example, based on a request and/or periodically, the certification system 304 may seek authentication of uncertified document snapshot references 316, including the uncertified document snapshot reference that was generated and stored in block 610. To perform the certification, the certification system 304 may provide a prompt to the SME device 110.

At block 614, the SME device 110 may query document versions from the document repository 604. For example, the SME device 110 may provide a request directly to the document repository 604 to request all versions of the first document that is stored within the document repository. In some instances, the SME device 110 may provide the request to the certification system 304, and the certification system 304 may facilitate the retrieval of the versions of the first document.

Referring to FIG. 6B, at block 616, the document repository 604 provides a list of document versions of the first document to the SME device 110. For example, based on the query from block 614, the document repository 604 may search for versions of the first document (e.g., all versions of the first document), and provide the list to the SME device 110.

At block 618, the SME device 110 identifies a version fit for certification. For example, the SME 108, using the SME device 110, may review one or more versions of the first document from the document repository 604, and provide input identifying that a version is ready for certification.

At block 620, the SME device 110 identifies certification time boundaries, and obtain input from the SME 108 indicating the certification time boundaries. Additionally, and/or alternatively, the SME device 110 may obtain input from the SME 108 indicating additional metadata. For example, referring to FIG. 3B, one or more fields may be from the SME device 110 at block 620. For instance, the SME 108, using the SME device 110, may provide input indicating the person certifying the document (e.g., field 336), the date of certification (e.g., field 338), and the duration of certification (e.g., fields 340-342). Additionally, and/or alternatively, the SME 108, using the SME device 110, may provide additional input such as notes (e.g., field 344).

At block 622, the SME device 110 certifies the designated document version for a specific time (e.g., indicated based on block 620), and provides the certification to the document database 312 (e.g., a certification indication from the SME 108 that is provided by the SME device 110 to the federated KB computing platform 112). For example, based on the input from the SME 108, the SME device 110 may update the snapshot reference within the document database 312. For instance, as mentioned above, after the author authored the new version of the first document, an uncertified document snapshot reference may be stored within the document database 312. Here, based on the certification information from the SME device 110 indicating the certification, the federated KB computing platform 112 may generate (e.g., update and/or modify) a certified document snapshot reference for the new version of the first document. For instance, based on the certification information the federated KB computing platform 112 may update the uncertified document snapshot reference for the new version of the first document such that this snapshot reference becomes a certified document snapshot reference. Furthermore, the federated KB computing platform 112 may include additional certification information from the SME 108 into the certified document snapshot reference. For instance, the federated KB computing platform 112 may include the input from the SME 108 such as the person certifying the document (e.g., field 336), the date of certification (e.g., field 338), the duration of certification (e.g., fields 340-342), and/or additional input such as notes (e.g., field 344).

At block 624, the document database 312 stores the certified document snapshot reference into the document database 312. For instance, based on the certification information and/or the updates/modifications, the federated KB computing platform 112 may obtain a certified document snapshot reference such as the snapshot reference 320 shown in FIG. 3B, which includes the fields 336-334 from the SME 108, the identifiers 328-330, and other information. Then, the federated KB computing platform 112 may store the certified document snapshot reference into the document database 312. Following, process 400 may be used to retrieve the certified document snapshot reference, and then use the certified document snapshot reference.

In other words, referring to event sequence 600, the author, the federated KB computing platform 112, and the SME 108 may perform certain steps.

For example, at blocks 606 and 608, the author may author a project such as a tax calculator service, and then author the first document. The first document may be an API md file, the type of the document repository 604 may be GITHUB Enterprises, and the name of the document repository 604 may be a tax repository. In some instances, to register the document with the document repository 604 (e.g., a KB computing system 114), the author device 602 may provide data such as the title, uncertified identifier, keywords, vectors, and/or notes. For instance, the additional data may include the title (e.g., the title shown in FIG. 3B in field 326), the uncertified identifier (e.g., the identifier shown in FIG. 3B in field 328), the keywords and vectors (e.g., the keywords and vectors shown in FIG. 3B in fields 332 and 334), and a note such as “This is an uncertified document API.md.” The author may further maintain the project version history for the document repository 604, and determine whether the project has reached a release phase. Based on the project reaching the release phase, the author may change the note to “Release v1,” and request the certification.

The document repository 604 may be a KB computing system 114 that records, tracks, and maintains both certified and uncertified document snapshot references, along with a variety of data helpful towards discovery, such as keywords (for traditional keyword search) and document vectors (for AI search). Additionally, and/or alternatively, the document repository 604 may track the governance time period, and mark the document as “expired” when the certification period runs out. The document repository 604 may also provide other document flags such as “obsolete” or “superseded.”

The document repository 604 and the federated KB computing platform 112 may work together to perform federated knowledge governance. For instance, based on the information from the author, at block 608 and 610, the federated KB computing platform 112 may generate and store an uncertified document snapshot reference for the first document (e.g., the tax calculator service snapshot reference). Then, based on the author determining that the project has reached a release phase and tagging the appropriate commit, at block 612, the federated KB computing platform 112 may perform block 612 and provide a prompt indicating that this new version needs certification. For example, the author device 602 may provide a request to the document repository 604 indicating that the project has reached a release phase and the new version of the first document is ready for certification (e.g., the version “4f5e68” of the first document). The document repository 604 may provide the request to the federated KB computing platform 112, and the federated KB computing platform 112 may perform block 612.

Following, the federated KB computing platform 112 and the SME device 110 may work together to perform the certification. For instance, after receiving the certification request, the SME device 110 may perform block 612 to retrieve a list of document versions, and perform blocks 618-622 to provide the certification information.

After, if valid, the SME device 110 may indicate that the document version in the document repository 604 (e.g., the document version “4f5e68”) is valid. The SME device 110 may provide the indication to the document repository 604 and/or the federated KB computing platform 112. Afterwards, the uncertified document snapshot reference associated with the document version may be updated such as by including fields 330 and 332-344 as described above.

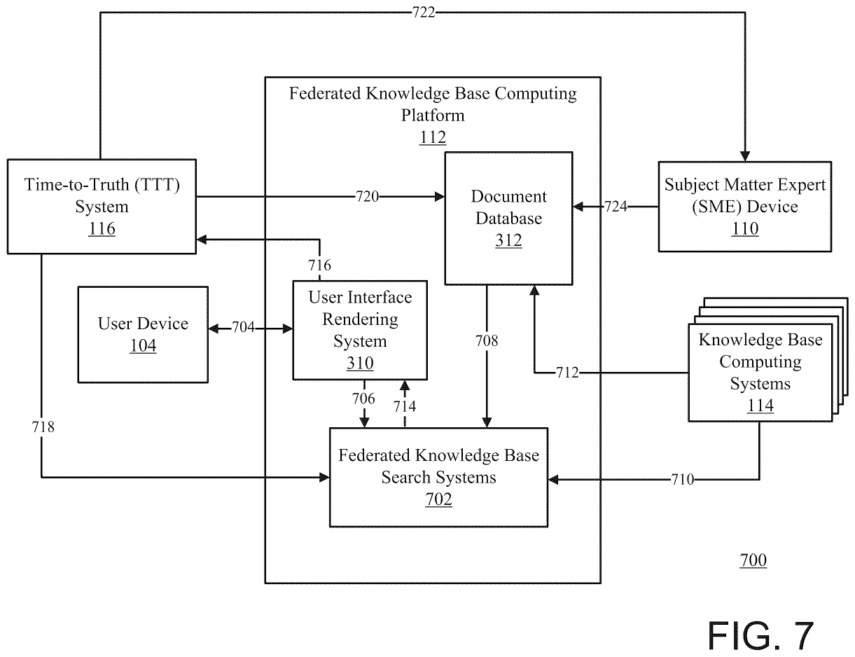

FIG. 7 is another simplified block diagram depicting an overview 700 of using TTT metric for KM in accordance with one or more examples of the present application. The overview 700 includes the TTT system 116, the user device 104, the federated KB computing platform 112, the SME device 110, and the KB computing systems 114. In addition, the overview 700 shows the data paths and/or communications between each of the entities within the overview 700. As shown in overview 700, the TTT system 116 is separate from the federated KB computing platform 112. However, as mentioned above, in some variations, the TTT system 116 may be included within the federated KB computing platform 112.

The federated KB computing platform 112 includes the document database 312, the user interface rendering system 310, and the federated KB search systems 702. For example, the federated KB search systems 702 may include the search system 306 and the generative AI search system 308 from FIG. 3A, which are described above. In some examples, the federated KB search systems 702 may include a RAG AI model that is configured to perform searching of the KB computing systems 114 to generate results that are responsive to the user query.

In some examples, the overview 700 may describe several modular components and/or processes including a core process, a certification process, and/or a search process (e.g., a RAG/AI search process). For example, the core process may track a user session through the federated KB computing platform 112 using in-the-moment feedback and may measure the quality of the search results from the federated KB search systems 702. The certification process may indicate whether the SME certification is used, which is described above. Furthermore, the certification process may validate the search query for the intended match to the certified document topic. Additionally, and/or alternatively, quality metrics feedback (e.g., the TTT metric) may also be provided to the SME device 110, and the SME may use the quality metrics feedback to improve the document. The search process may use an RAG/AI search process, and the quality metrics feedback (e.g., the TTT metric) may be used to update the AI model.

In operation, the user device 104 may provide and/or receive information 704 from the user interface rendering system 310. For example, using the user device 104, the user 102 may communicate with the user interface rendering system 310 such as providing a query (e.g., a search and/or conversational query) to the federated KB computing platform 112. Additionally, and/or alternatively, prior to providing the query, the user device 104 and/or the user interface rendering system 310 may provide messages (e.g., information 704) back and forth. After receiving the query, the user interface rendering system 310 may provide information 706 to the federated knowledge base search systems 702.

The federated KB search systems 702 may parse the query from the user device 104 and extract intent and/or embeddings associated with the search query. For example, the federated KB search systems 702 may include and/or utilize a RAG AI model and/or engine. Based on including and/or utilizing the RAG AI model/engine, the federated KB search systems 702 may parse and extract the intent and embeddings from the query.

The federated KB search systems 702 may further retrieve information 708 (e.g., document metadata such as identifiers and/or embeddings that may include certification data) from the document database 312. For example, as mentioned above, the document database 312 may include vector data (e.g., for the snapshot reference 320, FIG. 3B shows the vectors 334). Based on the vector data from the document database 312 and/or the extracted intent and/or embeddings, the federated KB search systems 702 may determine one or more documents to include within the search results. For example, in some instances, the federated KB search systems 702 may compare the extracted intent and/or embeddings from the query with the vector data for the different snapshot references within the document database 312. Based on the comparison, the federated KB search systems 702 may determine/identify the documents and/or document snapshot references that are most similar to the extracted intent and/or embeddings from the query. For instance, in some variations, the federated KB search systems 702 may use cosine similarity to compare the vector associated with the intent and/or embeddings from the query with the vector data for the snapshot references within the document database 312. Based on the cosine similarity scores associated with the snapshot references, the KB search systems 702 may determine and/or identify documents to include within the search results (e.g., identify the storage location of the documents with the KB computing systems 114).

In other words, the federated KB search systems 702 may generate a query vector associated with the query from the user device 104 (e.g., based on extracting intent and/or embeddings from the query). Subsequently, as mentioned above (e.g., FIG. 3B), the document database 312 may include vectors for the different snapshot references. The federated KB search systems 702 may perform one or more algorithms, processes, and/or methods (e.g., cosine similarity) to determine a set of snapshot references that are associated with documents from the KB computing systems 114 that are most aligned with the query. For instance, the federated KB search systems 702 may perform a cosine similarity comparison to determine the set of snapshot references for the query from the user device 104. Afterwards, the federated KB search systems 702 may further retrieve information 708, which may include information (e.g., metadata such as metadata 324 from FIG. 3B) associated with the snapshot references. For instance, as mentioned above, the snapshot references may include identifiers (e.g., uncertified and/or certified identifiers 328 and 330 that are shown in FIG. 3B), and the identifiers may be, in some examples, deep links that indicate storage locations of the actual documents within the KB computing systems 114. The retrieved information 708 may include the identifiers associated with the determined set of snapshot references. Additionally, and/or alternatively, the retrieved information 708 may include certification information associated with the set of snapshot references (e.g., certification information 336-342 from FIG. 3B). For instance, the certification information may indicate a name of the SME 108 that certified the document, a date of certification, a duration of certification, and/or other certification information.

In some examples, the federated KB search systems 702 may provide the information 708 directly back to the user device 104 (e.g., via the user interface rendering system 310). The user device 104 may use the identifiers (e.g., deep links) indicated with the information 708 to access the documents from the KB computing systems 114.

In other examples, the federated KB search systems 702 may further retrieve content from the documents from the KB computing systems 114. For example, based on the identifiers, the federated KB search systems 702 may retrieve content associated with the identifiers from the KB computing systems 114. For instance, the federated KB search systems 702 may provide a query to the KB computing systems 114. The KB computing systems 114 may provide information 710 back to the federated KB search systems 702, and the information 710 may include the content associated with the identifiers.

Afterwards, using the information 710, the federated KB search systems 702 may generate information 714 (e.g., the content from the search results that were obtained from the KB computing systems 114), and provide the information 714 to the user interface rendering system 310. The user interface rendering system 310 may cause display of the search results on the user device 104, and the user 102 may review the search results.

Furthermore, the user interface rendering system 310 may include a plurality of components or entities such as chat user interfaces (UIs), widgets, gadgets, and/or TTT instrumentations. For instance, the chat UIs, widgets, and/or gadgets may be used to facilitate the search process for the user device 104. The TTT instrumentation may be used to generate TTT instrumentation information associated with the search results that are provided by the federated KB search systems 702. For example, the TTT instrumentation information may include user feedback information (e.g., user quality feedback) and/or journey information. Using the TTT instrumentation, the user interface rendering system 310 may provide the TTT instrumentation information (e.g., the user feedback information and/or the journey information) to the TTT system 116.

In some examples, the TTT instrumentation information may include user feedback information. For example, the user interface rendering system 310 may cause display of a screen on the user device 104 that indicates the search results (e.g., the identifiers from the document database 312 and/or the content from the documents from the KB computing systems 114). For instance, the initial display screen of the user device 104 may indicate a plurality of search results that were generated by the federated KB search systems 702 (e.g., a list of search results). The user 102 may decide to select one or more search results from the list and provide user input to the user device 104 indicating the selection. Based on user selection, the user device 104 may display content associated with the selection. For instance, in some examples, the user interface rendering system 310 may obtain user input indicating the selection. Based on information 714, the federated KB search systems 702 may have already retrieved the content for that selection, and the user interface rendering system 310 may cause display the content on the user device 104. In addition to displaying the content, the user interface rendering system 310 may further cause display of one or more prompts on the user device 104. For instance, the one or more prompts may solicit a user response such as whether the user 102 found the displayed content to be helpful. For example, the one or more prompts may indicate two user selections—a thumbs up and a thumbs down. The thumbs up may indicate that the user 102 found the displayed content to be helpful and relevant to their search query and the thumbs down may indicate that user 102 did not find the displayed content to be helpful. The prompts indicating a thumbs up or a thumbs down is merely exemplary and the prompts may be any type of prompts that the user 102 may be able to interact with (e.g., a prompt indicating a field for the user 102 to type their feedback regarding the displayed content).

Additionally, and/or alternatively, the user device 104 may provide one or more additional user selections for other selections from the list of search results, and the federated KB computing platform 112 may display content associated with the additional user selections. The user interface rendering system 310 may further display prompts for the content associated with the additional user selections and may obtain user feedback for the additionally displayed content. In other words, the user interface rendering system 310 may obtain user feedback information indicating user input associated with content from the search results that were provided by the federated KB search systems 702. The user input may indicate the relevance or usefulness of content from search results.

In some examples, using the user device 104, the user 102 may provide multiple search queries. For instance, if the initial search results were inadequate (e.g., did not answer the initial user query), the user device 104 may provide one or more additional search queries to the federated KB computing platform 112. The additional search queries may be modified versions of the initial search query. The federated KB search systems 702 may generate new search results and provide the new search results to the user device 104. The user 102, using the user device 104, may review the new search results and may provide user input indicating whether the content from the new search results are relevant. As such, the user feedback information may indicate user feedback associated with content from the one or more queries (e.g., content from the first query, second query, and so on).

Additionally, and/or alternatively, the TTT instrumentation information may include journey information. For instance, whereas the user feedback information may indicate explicit user input, the journey information may indicate information associated with the journey of the user 102. For example, in some instances, it may be difficult to obtain user engagement in providing their feedback. In addition, even when there is user engagement (e.g., the user 102 providing the user input for the user feedback information), it might not tell the entire story regarding the query and search results associated with the query. As such, the user interface rendering system 310 may seek to capture journey information that captures the actual interaction of the user 102 while the user 102 is reviewing the search results. For instance, the user interface rendering system 310 may obtain information indicating a duration that the user 102 spent reviewing content from a particular document from the search results. Additionally, and/or alternatively, the user interface rendering system 310 may obtain information indicating movement of the eyes of the user 102 as the user 102 is reviewing content from the search results. Additionally, and/or alternatively, the user interface rendering system 310 may track the user selections (e.g., the “clicks” of the user 102). Additionally, and/or alternatively, as mentioned above, the user device 104 may provide multiple queries to the federated KB computing platform 112. The user interface rendering system 310 may obtain information for the multiple queries such as the differences between the initial query and the subsequent queries. The user interface rendering system 310 may generate the journey information based on the above information. In other words, the user interface rendering system 310 may track any interactions or engagement of the user 102 while the user 102 is reviewing the search results, and may generate the journey information based on the interactions and/or engagement. To put it another way, whereas the user feedback information may indicate explicit user input, the journey information may indicate user interactions and/or engagements associated with the search results. Thus, in some examples, the journey information may indicate behavioral information of the user 102 (e.g., if the content for a document is eight pages long and the user 102 only reviewed the content for thirty seconds, the journey information may indicate that the user 102 did not find the document to be relevant).

After obtaining the TTT instrumentation information (e.g., the user feedback information and/or the journey information described above), the user interface rendering system 310 may provide the TTT instrumentation information 716 to the TTT system 116. Using the TTT instrumentation information 716, the TTT system 116 may determine (e.g., compute, calculate, and/or generate) a TTT metric. As mentioned above, the TTT metric may indicate an amount of time for the user to be satisfied with the results from the federated KB search systems 702. For instance, in an example where content from the first document that the user 102 reviewed was relevant and the user 102 ended their search, the TTT system 116 may determine a TTT metric that indicates that the federated KB search system 702 generated sufficient results. If content from the initial search results was inadequate and the user device 104 provided one or more additional search queries to the federated KB computing platform 112, the TTT system 116 may determine a TTT metric that indicates that the federated KB search system 702 generated inadequate results for the initial search query.

In some instances, the TTT system 116 may include a database such as a telemetry database. The telemetry database may store the TTT instrumentation information for the user 102 as well as other users and/or other user devices. For example, the telemetry database may store the TTT instrumentation information 716 for a plurality of users that utilize the federated KB computing platform 112, the federated KB search system 702, and/or the KB computing systems 114.

The TTT system 116 may compute the TTT metrics based on the TTT instrumentation information from the telemetry database. For instance, the TTT system 116 may include an analytic engine and/or processor that computes the TTT metrics based on the TTT instrumentation information. The TTT system 116 may use any process, method, and/or algorithm to determine the TTT metrics. For example, in some instances, the TTT system 116 may use a mathematical formula and/or a Bayesian computation to determine the TTT metric. Additionally, and/or alternatively, the TTT system 116 may include and/or be associated with an ML-AI model (e.g., a TTT ML-AI model). The TTT system 116 may train the TTT ML-AI model, and may use the trained TTT ML-AI model to parse through the TTT instrumentation information from the telemetry database to determine and/or generate the TTT metric. The computation and/or determination of the TTT metrics is described in further detail below.

Subsequently, based on the TTT metric, the TTT system 116 may generate and provide information to update the search process that is performed by the federated KB computing platform 112. For example, as mentioned above, the federated KB search systems 702 may use an ML-AI search algorithm such as a RAG AI algorithm to generate the search results from the user query. As such, based on the TTT metric, the federated KB search systems 702 may generate and provide information 718 to update the ML-AI search algorithm that is used to generate the search results. For instance, the TTT system 116 may provide information 718 indicating the TTT metric to the federated KB search systems 702. Based on the TTT metric, the federated KB search systems 702 may perform further training of the ML-AI search algorithm. For example, based on the TTT metric, the federated KB search systems 702 may update the weights and/or parameters of the ML-AI search algorithm. Additionally, and/or alternatively, the TTT system 116 may provide information 718 indicating the updated weights and/or parameters for the ML-AI search algorithm to the federated KB search systems 702, and the federated KB search systems 702 may update the ML-AI search algorithm based on the indicated updated weights and/or parameters from the TTT system 116.

Additionally, and/or alternatively, based on the TTT metric, the TTT system 116 may update the document vector embeddings within the document database 312. For example, as mentioned previously, the document database 312 may include vectors associated with the snapshot references (e.g., the vectors 334 from FIG. 3B). Based on the TTT metric, the TTT system 116 may generate updated vector embeddings for the snapshot references. Then, the TTT system 116 may provide information 720 indicating the updated vector embeddings to the document database 312. The updated vector embeddings for the snapshot references may replace the previous vector embeddings within the document database 312.

Additionally, and/or alternatively, based on the TTT metric, the TTT system 116 may provide information 722 indicating the TTT metric to the SME device 110. The SME device 110 may then provide information 724 to the document database 312. For instance, as mentioned above, the snapshot references within the document database 312 may indicate certification information. Based on the TTT metric, the SME device 110 may update the certification information and/or other information for the snapshot references and may provide the information 724 to the document database 312 based on the update. For example, the TTT system 116 may provide information 722 indicating document quality feedback, which may be based on the TTT metric. The document quality feedback may indicate, for instance, that one or more documents from the search results was not relevant to the user 102. The SME 108, using the SME device 110, may review the document quality feedback and determine result relevance feedback. For example, the SME 108 may determine that the document is good, but it was returned for the wrong query. The SME device 110 may provide information 724 indicating the SME feedback. Additionally, and/or alternatively, the SME 108 may indicate that the certified document was lacking for one or more reasons, and the SME device 110 may provide information 724 to update the metadata for the snapshot reference for the document. The usage of the TTT metric (e.g., information 718-724) will be described in further detail below.

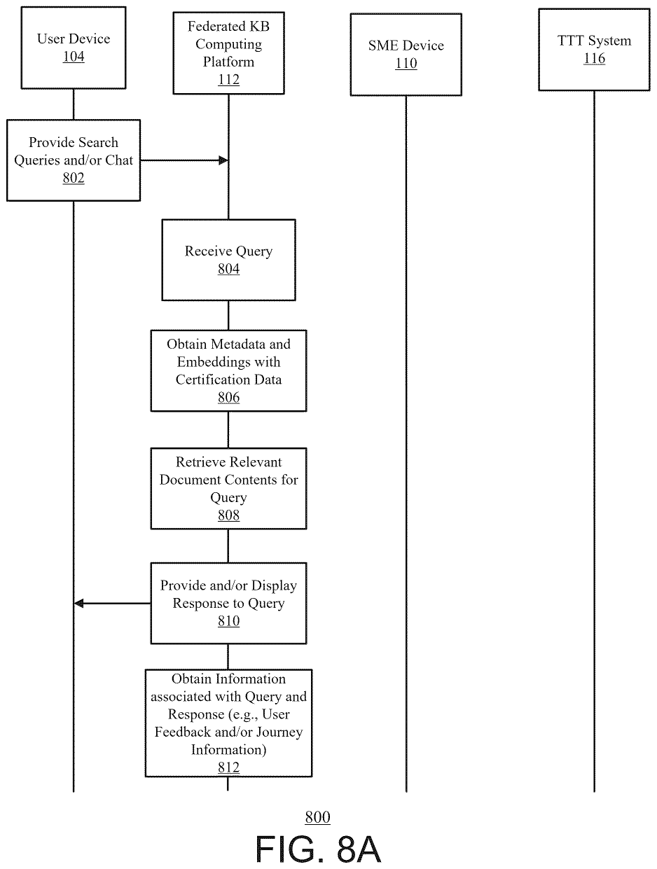

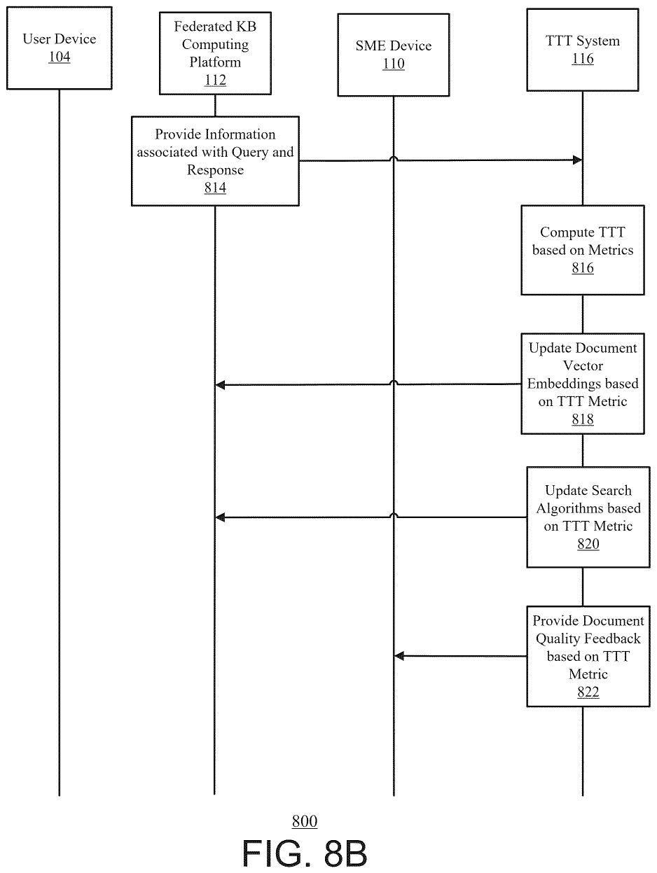

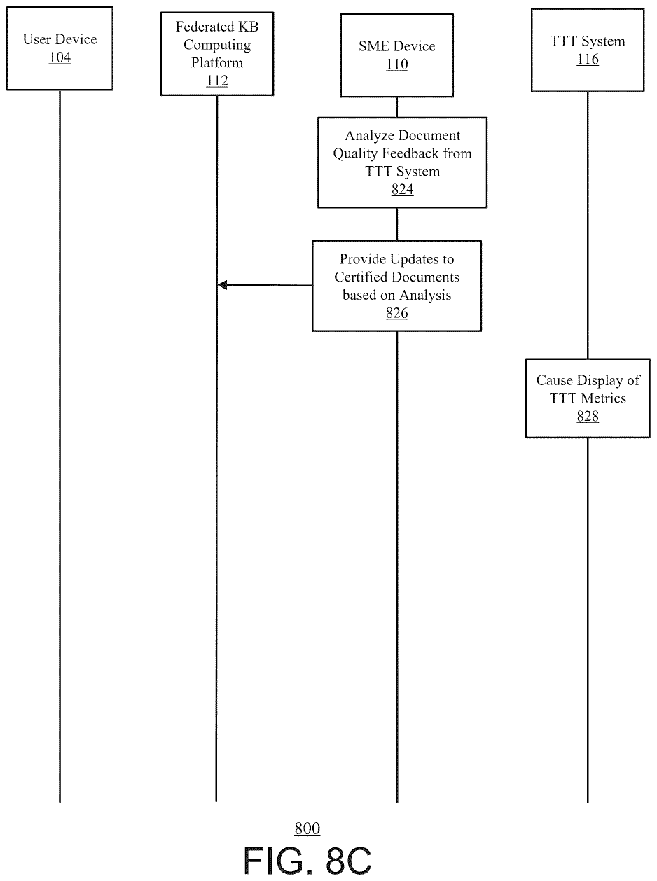

FIGS. 8A-8C show an exemplary event sequence 800 for using the TTT metric for KM in accordance with one or more examples of the present application. However, the event sequence 800 is merely an example and other types of event sequences are contemplated herein including by performing any of the following blocks in any suitable order. The event sequence 800 includes operations, processes, and/or functions that are performed by one or more entities. For example, the event sequence 800 includes blocks performed by the user device 104, the federated KB computing platform 112, the SME device 110, and the TTT system 116.

In operation, referring to FIG. 8A, at block 802, the user device 104 provides search queries and/or chat to the federated KB computing platform 112. At block 804, the federated KB computing platform 112 receives the query. For example, as mentioned previously, the user device 104 may provide a query such as a question to the federated KB computing platform 112.

At block 806, the federated KB computing platform 112 obtains metadata and embeddings with certification data. For instance, based on the query, the federated KB computing platform 112 may retrieve metadata and/or embeddings with the certification data from the document database 312. At block 808, the federated KB computing platform 112 retrieves relevant document contents for the query (e.g., from the KB computing systems 114). At block 810, the federated KB computing platform 112 provides and/or displays responses to the query (e.g., the content from the search results).

At block 812, the federated KB computing platform 112 obtains information associated with the query and response (e.g., the TTT instrumentation information that may include the user feedback information and/or the journey information). Referring to FIG. 8B, at block 814, the federated KB computing platform 112 may provide the information associated with the query and response (e.g., the TTT instrumentation information) to the TTT system 116. At block 816, the TTT system 116 may compute the TTT based metrics (e.g., a TTT metric).

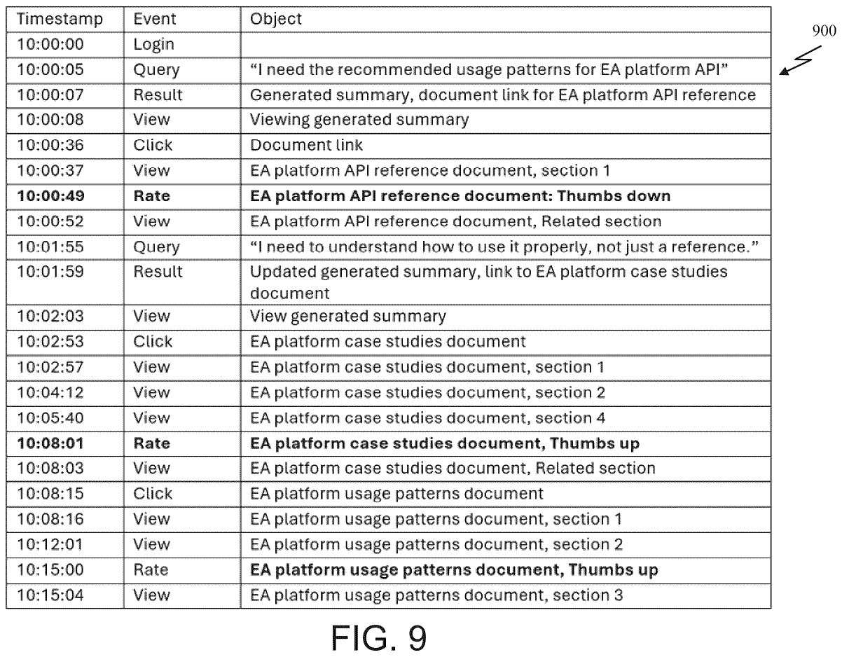

For example, the TTT may be a metric for measuring the holistic quality of the federated KB computing platform 112 and/or the KB computing systems 114. Using the TTT instrumentation information, the TTT system 116 may compute the TTT metric. For instance, in some examples, the TTT instrumentation information may include an event log associated with interactions between a user 102 and the federated KB computing platform 112. An exemplary event log is shown in FIG. 9. FIG. 9 shows an exemplary event log 900 that is based on a user query in accordance with one or more examples of the present application. For instance, the user 102 may seek information on how to interact with an application programming interface (API) for an Enterprise Architecture (EA) platform. The federated KB computing platform 112 may display an API document as an initial response, but the user 102 might not find the initial document as relevant and may provide user feedback indicating a thumbs down (e.g., based on interacting with the feedback UI element that is provided by user interface rendering system 310). The user 102 may further amend the query and provide the query to the federated KB computing platform 112. The federated KB computing platform 112 may provide additional results (e.g., resulting documents, case studies and so on) to the user 102. The user 102 may finally obtain the document (e.g., a usage patterns document) that they are seeking. For instance, the user 102 may click on the usage patterns document and obtain the answer that they are seeking in a section of the document (e.g., a “related” section of the document). The user interface rendering system 310 may gather the TTT instrumentation information and generate an event log 900 that includes timestamps, events, and objects (e.g., descriptions). For instance, a “rate” event may indicate user feedback that is captured in the user feedback information. The other events such as the “view” or “click” events may be captured in the journey information. The TTT instrumentation information may be provided to the TTT system 116, and the TTT system 116 may compute the TTT metric based on the TTT instrumentation information.

For instance, referring back to FIG. 8B, the TTT system 116 may compute the TTT metric based on one or more algorithms, processes, and/or methods. In some instances, the TTT system 116 may use an algorithmic approach and/or calculation. For example, the TTT system 116 may utilize a last positive feedback from the user 102 to determine the TTT metric. For instance, referring to the event log 900, the user 102 provides user input indicating a Thumbs up at “10:15:00”. The TTT system 116 may retrieve a time stamp associated with the user input indicating the last positive feedback and identify the document that the user input is associated with (e.g., the usage patterns document). The TTT system 116 may further backtrack to the initial engagement with that document (e.g., at timestamp “10:08:15”) and subtract that with the initial engagement with the federated KB computing platform 112 (e.g., the first query was provided at timestamp “10:00:05). Based on the above, the TTT system 116 may determine the TTT metric. For instance, the TTT system 116 may subtract the timestamp for the initial engagement with the positive document (e.g., the timestamp “10:08:15”) with the timestamp for the initial engagement with the federated KB computing platform 112 (e.g., the timestamp “10:00:05) to obtain the TTT metric (e.g., eight minutes and ten seconds). In some instances, the TTT system 116 may perform one or more normalization algorithms and/or processes to normalize the TTT metric (e.g., the eight minutes and ten seconds may be a raw TTT metric and the TTT system 116 may normalize the raw TTT metric to obtain a normalized TTT metric). The normalization algorithms and/or processes may include linear and/or logarithmic algorithms, processes, and/or computations. Additionally, and/or alternatively, a numeric cutoff that may serve as a top end of the scale may be used if a bounded metric is desirable.

Additionally, and/or alternatively, the TTT system 116 may use an ML-AI model or algorithm (e.g., a TTT ML-AI model) to compute the TTT metric. For example, at the end of the user journey, the federated KB computing platform 112 may provide a survey to the user device 104 (e.g., probabilistically and/or unobtrusively ask the user 102 to take a user 102). For instance, in a percentage of usages of the federated KB computing platform 112 (e.g., a 5% chance), a second prompt may be provided by the user interface rendering system 310 back to the user device 104. The second prompt may ask the user 102 whether they would be willing to participate in a survey. Based on user feedback, the federated KB computing platform 112 may provide the survey and collect survey information indicating the user journey including intent of the user 102. The TTT system 116 may obtain the survey information and match the TTT instrumentation information (e.g., the event log 900) with the intent indicated by the survey information from the user 102. For instance, the user 102 may provide survey information indicating which documents gave them the answer that they were looking for (e.g., the usage patterns document) and how relevant/what quality the answer was.

Based on the survey information and the TTT instrumentation information (e.g., the event log 900), the TTT system 116 may train the TTT ML-AI model. For example, the TTT system 116 may process the TTT instrumentation information using the TTT ML-AI model to obtain an output (e.g., the TTT metric), and may use the survey information as training supervision. As such, in some examples, the TTT system 116 may use a supervised training approach to train the TTT ML-AI model to generate the TTT metric. In some examples, based on receiving new TTT instrumentation information and/or new survey information from new users, the TTT system 116 may continuously train the TTT ML-AI model. Then, during inference, the TTT system 116 may process the TTT instrumentation information using the TTT ML-AI model to generate the TTT metric.

Additionally, and/or alternatively, the TTT system 116 may use a Bayesian computation (e.g., a Bayesian algorithm) to determine the TTT metric. For example, The Bayes' Theorem may allow for determining the probability of a cause given its effect, which may be expressed as follows:

$$P ( A \vert B ) = \frac{P ( B \vert A ) P ( A )}{P ( B )} \frac{P ( B \vert A ) P ( A )}{P ( B \vert A ) P ( A ) + P ( B \vert ¬ A ) P ( ¬ A )}$$

where A and B are events and P(B) is not equal to 0. Further, P(A|B) is a conditional probability: the probability of event A occurring given that B is true, P(B|A) is also conditional probability: the probability of event B occurring given that A is true, and P(A) and P(B) are unconditional probabilities of A and B occurring, respectively.

For computing the TTT metric, the TTT system 116 may use the Bayes' Theorem to infer the probability that a given document A was in fact the document sought by the user 102, given the user input in the TTT instrumentation information (e.g., the event log 900). For instance, P(A) is the probability that the given document A is the desired (“truth”, or “Answer”) document out of all documents the user 102 viewed and P(B) is the probability that the user 102 will click on the “feedback” UI element (e.g. a “thumbs up/down” widget) when seeing their desired (“truth”) document.

To correctly calculate the probability that the given document A is desired, four “priors” are determined. For instance, the first prior may be P(B|A) or the probability that the user 102 clicks on the “feedback” UI element (e.g., a “thumbs up/down” widget) when the user 102 finds what they want, and rates it thumbs up. The second prior may be P(B|¬A) or the probability that the user 102 clicks on the “feedback” UI element (e.g., a “thumbs up/down” widget) when it is not the “truth” document, and rates it thumbs up. The third prior may be P(A) or the probability that a given document includes what the user 102 was looking for, out of the documents they viewed (e.g., is the “truth” document). Further, from the expression above, a fourth prior, P(¬A) or the probability that a given document does not include what the user 102 was looking for (e.g., 1−P(A)), may be determined.

To obtain the priors, the user survey (e.g., the survey information that was collected by the user interface rendering system) and/or the TTT instrumentation information may be used. For instance, for the first prior, the user survey may indicate whether the users 102 found what they were looking for and in which document. Given that the TTT instrumentation information already indicates whether they rated that document positively, the TTT system 116 may determine the first prior based on the TTT instrumentation information and the user survey. In an example, the first prior may indicate a value of 0.5 (e.g., the users 102 rated the “truth” document 50% of the time).

For the second prior, the user survey may indicate whether the users 102 found what they were looking for and in which document(s). Given that the TTT instrumentation information already indicates whether they rated any other documents positively (e.g., documents that are non-“truth” documents), the TTT system 116 may determine the second prior based on the TTT instrumentation information and the user survey. In an example, the second prior may indicate a value of 0.20 (e.g., the users 102 rated the non-“truth” documents positively 20% of the time), which may indicate the document was not the document that the user 102 found useful, but it was still a good document. For the third prior, the user survey may indicate whether they found what they were looking for, and the TTT system 116 may compute a ratio of the “truth” documents to the total documents viewed. In an example, the third prior may indicate a value of 0.3 (e.g., on average, 3 in 10 documents are “truth” documents in the aggregated user KB interactions).

The TTT system 116 may compute the priors based on the survey information, which is described above. Afterwards, taking the above expression and the above example values as well as P(¬A) being 0.7, the expression becomes:

$$\frac{0.5 \times 0.3}{0.5 \times 0.3 + 0.2 \times 0.7} = \frac{0.15}{0.15 + 0.14} = \frac{0.15}{0.29} = . 52$$

Thus, in this example, the TTT system 116 may determine a ratio that a given document has a 52% chance of being a “truth” document if the user 102 provided user input indicating a “thumbs up” on it. The TTT system 116 may use the ratio to weigh the raw TTT metric that was computed in the first method to compute the actual TTT metric (e.g., divide the raw TTT value of eight minutes and ten second (490 seconds) by 0.52, which would result in an actual TTT metric of 15 minutes and 42 seconds (942 seconds)). The above examples for computing the TTT metric are merely exemplary and the TTT system 116 may use any algorithm, process, and/or method to compute the TTT metric.

At block 818, the TTT system 116 may update the document vector embeddings within the federated KB computing platform 112 based on the TTT metric. For example, the TTT system 116 may decrease certain components of a document vector based on a combination of negative user feedback and the sentiment analysis of the user query. In other words, the TTT system 116 may generate information 720 indicating updates to components (e.g., entries) of the document vector based on negative user feedback and/or sentiment analysis of the user query, and may provide the generated information 720 to the federated KB computing platform 112. The federated KB computing platform 112 may update the document vector within the document database 312 based on the information 720.

At block 820, the TTT system 116 may update the search algorithms based on the TTT metric. For example, the TTT system 116 may determine that the RAG system's sentiment analysis was inadequate, and suggest the usage of an alternative sentiment analyzer, possibly only for some specific set of contexts (e.g., some sentiment analyzers may perform better on technical queries such as of a technical KB and others may perform better on general queries such as of an HR KB). In other words, the TTT system 116 may generate information 718 indicating usage of certain RAG AIs (e.g., sentiment analyzers) for certain KBs from the KB computing systems 114. For example, based on the TTT metric, the TTT system 116 may generate information 718 indicating to use one or more first RAG AIs for technical KBs from the KB computing systems 114 and one or more second RAG AIs for general KBs (e.g., HR KBs) from the KB computing systems 114.

At block 822, the TTT system 116 may provide document quality feedback to the SME device 110 based on the TTT metric. Referring to FIG. 8C, at block 824, the SME device 110 may analyze the document quality feedback from the TTT system 116. Then, at block 826, the SME device 110 may provide updates to certified documents based on analysis. For example, as mentioned above, certain documents may be certified by an SME 108. As such, the same SME 108 or a different SME 108 may be provided document quality feedback, which may be used to update the search process if desired. For instance, the SME device 110 may obtain SME input indicating feedback from the SME 108. For instance, the feedback from the SME 108 may indicate whether particular aspects of the search process should be improved further such as the ML-AI search algorithm that was used by the federated KB search systems 702 and/or the metadata (e.g., the vector data) from the document database 312. In other words, the SME device 110 may provide SME feedback to indicate to further train specific domains (e.g., document embeddings within the metadata of the document database 312 and/or further model training of the ML-AI search algorithm). In some examples, the SME 108 may realize that they missed something within the certified document. As such, the SME device 110 may provide updates to the document database 312 of the federated KB computing platform 112 and/or the KB computing systems 114 to update the snapshot reference for the document and/or to update the document itself with the missing information.

In other words, in some examples, instead of providing updates to the certified documents, the SME 108 may analyze the document quality feedback from the TTT system 116 and determine to update other search processes and/or procedures associated with the federated KB computing platform 112. For example, the SME 108 may determine that the content of the document does not need to be updated, but instead, the ML-AI search algorithm was incorrect in identifying the document based on the search query. As such, the SME device 110 may obtain SME input from the SME 108, and generate/provide update information based on the SME input. For instance, the update information may indicate for the federated KB computing platform 112 to update the ML-AI search algorithm. Additionally, and/or alternatively, the SME 108 may identify that the search vectors (e.g., the vectors within the document database 312) may need to be updated. As such, the SME device 110 may obtain SME input from the SME 108, and generate/provide update information based on the SME input. For instance, the update information may indicate for the federated KB computing platform 112 to update search vectors associated with the document within the document database 312. In other instances, the SME 108 may determine that the certification information and/or content within the document needs to be updated. As such, the SME device 110 may obtain SME input from the SME 108, and generate/provide update information based on the SME input. For instance, the update information may indicate for the federated KB computing platform 112 to update the certification information for the document within the document database 312. Additionally, and/or alternatively, the update information may be provided to the KB computing systems 114 and may indicate for the KB computing systems 114 to update the document (e.g., the update information may include a new version of the document).

In some examples, the SME device 110 may further obtain the TTT instrumentation information from the federated KB computing platform 112. The SME device 110 may use the TTT instrumentation information as well as the TTT metrics and/or other information to generate the update information.

In some examples, one or more blocks 818-826 may be optional and might not be performed in every iteration of event sequence 800. For example, in some instances, the TTT system 116 may update the document vector embeddings and/or may update the search algorithms. For instance, the search results that were obtained might not include any certified documents. As such, the event sequence 800 might not perform blocks 822-826. In other instances, the TTT system 116 may only perform blocks 822-826.

At block 828, the TTT system 116 may cause display of the TTT metrics. For instance, the TTT system 116 may include and/or be associated with a dashboard that may be used to display the TTT metrics.

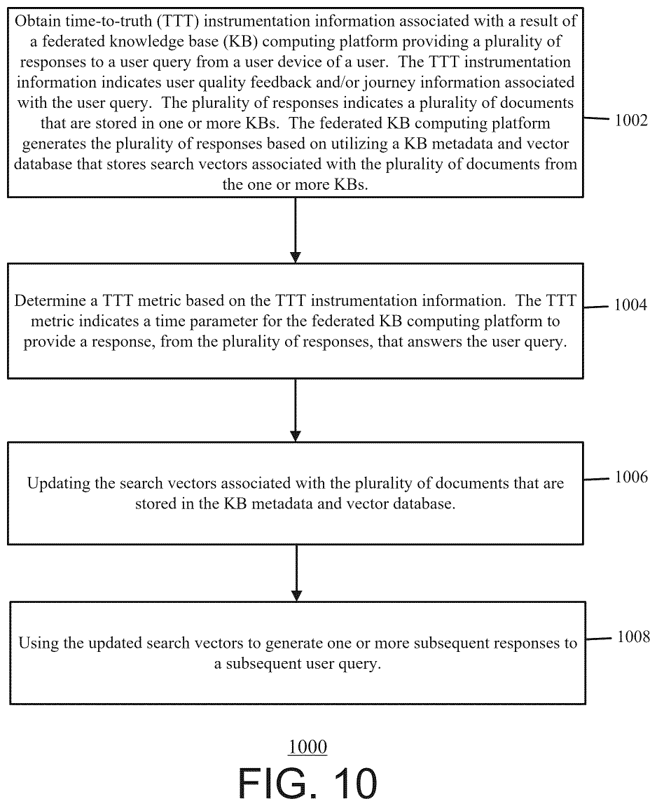

FIG. 10 is an exemplary process 1000 for using the TTT metric for KM in accordance with one or more examples of the present application. One or more blocks from process 1000 may be performed by the federated KB computing platform 112 and/or the TTT system 116 of environment 100 shown in FIG. 1. It will be recognized that any of the following blocks may be performed in any suitable order, and that the process 1000 may be performed in any suitable environment. The descriptions, illustrations, and processes of FIG. 10 are merely exemplary and the process 1000 may use other descriptions, illustrations, and processes for using the TTT metric for KM.

At block 1002, the TTT system 116 obtains TTT instrumentation information associated with a result of a federated KB computing platform providing a plurality of responses to a user query from a user device 104 of a user 102. The TTT instrumentation information indicates user quality feedback (e.g., user feedback information) and/or journey information associated with the user query. The plurality of responses indicates a plurality of documents that are stored in one or more KBs (e.g., the KB computing systems 114). The federated KB computing platform 112 generates the plurality of responses based on utilizing a KB metadata and vector database (e.g., the document database 312) that stores search vectors associated with the plurality of documents from the one or more KBs.

At block 1004, the TTT system 116 determines a TTT metric based on the TTT instrumentation information. The TTT metric indicates a time parameter for the federated KB computing platform 112 to provide a response, from the plurality of responses, that answers the user query.

At block 1006, the TTT system 116 updates the search vectors associated with the plurality of documents that are stored in the KB metadata and vector database.

At block 1008, the TTT system 116 uses the updated search vectors to generate one or more subsequent responses to a subsequent user query.

In some examples, the TTT system 116 might not be associated with a federated computing platform such as the federated KB computing platform 112. For example, the TTT system 116 may be associated with one or more individual KBs (e.g., one or more individual KB computing systems 114). In such examples, the individual KBs may utilize search systems that perform searches of their KBs to retrieve content that is provided back to the user device 104 and the user 102. Based on the user feedback and/or the journey of the user 102, the TTT system 116 and/or another system (e.g., a KB computing system 114) may generate the TTT instrumentation information. The TTT system 116 may generate TTT metrics based on the TTT instrumentation system, and use the TTT metrics for KM (e.g., update the search process for the individual KBs).

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A system, comprising:
a user device comprising:
one or more first processors; and
a first non-transitory computer-readable medium having first processor-executable instructions stored thereon, wherein the first processor-executable instructions, when executed by the one or more first processors, facilitate:
providing, based on user input from a user, a user query to a federated knowledge base (KB) computing platform; and
obtaining, from the federated KB computing platform and based on the user query, a plurality of responses indicating a plurality of documents that are stored in one or more KBs;
the federated KB computing platform comprising:
one or more second processors; and
a second non-transitory computer-readable medium having second processor-executable instructions stored thereon, wherein the second processor-executable instructions, when executed by the one or more second processors, facilitate:
obtaining the user query from the user device;
generating the plurality of responses indicating the plurality of documents based on utilizing a database that stores KB metadata and search vectors associated with the plurality of documents from the one or more KBs;
providing the plurality of responses to the user device;
generating time-to-truth (TTT) instrumentation information associated with providing the plurality of responses to the user device, wherein the TTT instrumentation information indicates a first user feedback associated with a first document from the plurality of documents; and
providing the TTT instrumentation information to a TTT system; and
the TTT system comprising:
one or more third processors; and
a third non-transitory computer-readable medium having third processor-executable instructions stored thereon, wherein the third processor-executable instructions, when executed by the one or more third processors, facilitate:
obtaining the TTT instrumentation information from the federated KB computing platform;
determining a TTT metric based on the TTT instrumentation information, wherein the TTT metric indicates a parameter for the federated KB computing platform to provide a response, from the plurality of responses, that answers the user query, wherein determining the TTT metric comprises:
analyzing the TTT instrumentation information to determine a first timestamp identifying an initial engagement of the first document associated with the first user feedback:
determining a second timestamp identifying when the user device provided the user query; and
determining the TTT metric based on subtracting the first timestamp and the second timestamp; and
providing the TTT metric to the federated KB computing platform,
wherein the second processor-executable instructions, when executed by the one or more second processors, further facilitate:
updating the search vectors associated with the plurality of documents that are stored in the database based on the TTT metric;
obtaining a subsequent user query; and
generating one or more subsequent responses to the subsequent user query based on the updated search vectors.

2. The system of claim 1, further comprising:
a subject matter expert (SME) device comprising:
one or more fourth processors; and
a fourth non-transitory computer-readable medium having fourth processor-executable instructions stored thereon, wherein the fourth processor-executable instructions, when executed by the one or more fourth processors, facilitate:
generating certification information for one or more documents from the plurality of documents that are stored in the one or more KBs;
providing the certification information to the federated KB computing platform, wherein the KB metadata comprises KB metadata for the one or more documents, wherein the KB metadata for the one or more documents comprises the search vectors and the certification information;
obtaining, from the TTT system, the TTT metric;
generating, based on the TTT metric, update information the federated KB computing platform; and
providing the update information to the federated KB computing platform.

3. (canceled)

4. The system of claim 2, wherein generating the update information comprises generating updated certification information for the one or more documents from the plurality of documents, and wherein the second processor-executable instructions, when executed by the one or more second processors, further facilitate:
updating the KB metadata for the one or more documents based on the updated certification information.

5. (canceled)

6. The system of claim 2, wherein the fourth processor-executable instructions, when executed by the one or more fourth processors, further facilitate:
obtaining SME input indicating to update a machine learning-artificial intelligence (ML-AI) search model that was used to generate the plurality of responses, wherein generating the update information is based on the SME input, and wherein the second processor-executable instructions, when executed by the one or more second processors, further facilitate;
prior to generating the one or more subsequent responses to the subsequent user query, updating the ML-AI search model based on the generated updated information.

7. The system of claim 1, wherein generating the plurality of responses comprises:
utilizing an artificial intelligence-machine learning (AI-ML) search model and the search vectors to determine the plurality of documents that are responsive to the user query; and
generating the plurality of responses based on the plurality of determined documents.

8. The system of claim 7, wherein the third processor-executable instructions, when executed by the one or more third processors, further facilitate:
generating updated parameters for the AI-ML search model based on the TTT metric; and
updating the AI-ML search model within the federated KB computing platform based on the updated parameters.

9. The system of claim 1, wherein the first user feedback associated with the first document indicates approval of the first document.

10. The system of claim 1, wherein the TTT instrumentation information comprises journey information indicating an event log that tracks user interactions with the federated KB computing platform.

11. The system of claim 1, wherein determining the TTT metric further comprises:
normalizing the TTT metric to obtain a normalized TTT metric, and wherein updating the search vectors is based on the normalized TTT metric.

12. The system of claim 1, wherein determining the TTT metric further comprises:
generating the TTT metric based on processing the TTT instrumentation information using a supervised machine learning-artificial intelligence (ML-AI) model.

13. The system of claim 12, wherein the third processor-executable instructions, when executed by the one or more third processors, further facilitate:
obtaining survey information from a plurality of users, wherein the survey information comprises user feedback indicating intents of the plurality of users when the plurality of documents are displayed to the plurality of users;
obtaining training TTT instrumentation information comprising training journey information indicating a plurality of event logs that track user interactions with the federated KB computing platform; and
training the supervised AI-ML model based on the survey information and the training TTT instrumentation information.

14. The system of claim 1, wherein determining the TTT metric is further based on performing a Bayesian algorithm using a first probability indicating that the response answers the user query and a second probability indicating a user feedback element is selected by a user of the user device.

15. A method, comprising:
obtaining time-to-truth (TTT) information associated with a result of a federated knowledge base (KB) computing platform providing a plurality of responses to a user query from a user device of a user, wherein the TTT instrumentation information indicates user feedback information and journey information associated with the user query, wherein the plurality of responses indicates a plurality of documents that are stored in one or more KBs, wherein the user feedback information comprises a first user feedback associated with a first document from the plurality of documents, and wherein the federated KB computing platform generates the plurality of responses based on utilizing a database that stores KB metadata and search vectors associated with the plurality of documents from the one or more KBs;
determining a TTT metric based on the TTT instrumentation information, wherein the TTT metric indicates a parameter for the federated KB platform to provide a response, from the plurality of responses, that answers the user query, wherein determining the TTT metric comprises:
analyzing the TTT instrumentation information to determine a first timestamp identifying an initial engagement of the first document associated with the first user feedback;
determining a second timestamp identifying when the user device provided the user query; and
determining the TTT metric based on subtracting the first timestamp and the second timestamp; and
updating the search vectors associated with the plurality of documents that are stored in the database based on the TTT metric, wherein one or more subsequent responses to a subsequent user query are generated based on the updated search vectors.

16. The method of claim 15, wherein the user feedback information indicates approval or disapproval of one or more documents from the plurality of documents that are indicated by the plurality of responses and the journey information indicates an event log that tracks user interactions with the federated KB computing platform.

17. The method of claim 15, wherein determining the TTT metric further comprises:
normalizing the TTT metric to obtain a normalized TTT metric, and wherein updating the search vectors is based on the normalized TTT metric.

18. The method of claim 15, wherein determining the TTT metric further comprises:
generating the TTT metric based on processing the TTT instrumentation information using a supervised machine learning-artificial intelligence (ML-AI) model.

19. The method of claim 15, wherein determining the TTT metric is further based on performing a Bayesian algorithm using a first probability indicating that the response answers the user query and a second probability indicating a user feedback element is selected by the user of the user device.

20. A non-transitory computer-readable medium having processor-executable instructions stored thereon, wherein the processor-executable instructions, when executed, facilitate:
obtaining time-to-truth (TTT) information associated with a result of a federated knowledge base (KB) computing platform providing a plurality of responses to a user query from a user device of a user, wherein the TTT instrumentation information indicates user feedback information and journey information associated with the user query, wherein the plurality of responses indicates a plurality of documents that are stored in one or more KBs, wherein the user feedback information comprises a first user feedback associated with a first document from the plurality of documents, and wherein the federated KB computing platform generates the plurality of responses based on utilizing a database that stores KB metadata and search vectors associated with the plurality of documents from the one or more KBs;
determining a TTT metric based on the TTT instrumentation information, wherein the TTT metric indicates a parameter for the federated KB platform to provide a response, from the plurality of responses, that answers the user query, wherein determining the TTT metric comprises:
analyzing the TTT instrumentation information to determine a first timestamp identifying an initial engagement of the first document associated with the first user feedback;
determining a second timestamp identifying when the user device provided the user query; and
determining the TTT metric based on subtracting the first timestamp and the second timestamp; and
updating the search vectors associated with the plurality of documents that are stored in the database based on the TTT metric, wherein one or more subsequent responses to a subsequent user query are generated based on the updated search vectors.

21. The system of claim 1, wherein determining the TTT metric further comprises:
obtaining survey information from a plurality of users;
determining, based on the survey information and the TTT instrumentation information, a first prior, a second prior, a third prior, and a fourth prior; and
determining the TTT metric based on processing the first prior, the second prior, the third prior, and the fourth prior using a Bayesian algorithm.

22. The system of claim 21, wherein:
the first prior is associated with a first probability that the plurality of users provided a first feedback for the first document;
the second prior is associated with a second probability that the plurality of users provided a second feedback for the first document;
the third prior is associated with a third probability that the first document is a truth document; and
the fourth prior is associated with a fourth probability that the first document is not the truth document.
